(19) United States
(12) Patent Application Publication
(10) Pub. No.: US 2026/0267280 A1
(43) Pub. Date: Sep. 10, 2026

(54) IMAGE FORMING APPARATUS

(71) Applicant: CANON KABUSHIKI KAISHA, Tokyo (JP)

(72) Inventors: Toshiaki Takeuchi, Shizuoka (JP); Makoto Hayashida, Shizuoka (JP); Ryuta Murakami, Shizuoka (JP)

(21) Appl. No.: 19/553,617

(22) Filed: Mar. 2, 2026

(30) Foreign Application Priority Data
Mar. 6, 2025 (JP) 2025-035942

(51) Int. Cl. G03G 21/16; G03G 15/00; G03G 15/08; G03G 21/18

(52) U.S. Cl. CPC G03G 21/1652; G03G 15/086; G03G 15/80; G03G 21/1619; G03G 21/1814; G03G 2221/1606; G03G 2221/163

(57) ABSTRACT

A downstream-side end of an electrical contact of the second unit is a first end and an upstream-side end thereof is a second end in a direction around the pivot axis when the second unit rotates from a spaced-apart position where a photosensitive drum and a developing roller are spaced apart from each other to a contact position where they come into contact with each other, a body contact of an apparatus body comes into contact with the electrical contact at a position between the first end and a midpoint between the first and the second ends in the contact position, and maintains the contact between the spaced-apart position and the contact position. When a distance from the pivot axis to the first end, the second end, and the middle point is D1, D2, and Dc, respectively Dc≤D1 and Dc≤D2 are satisfied.

### BACKGROUND

### Field of the Technology

The present disclosure relates to an image forming apparatus.

### Description of the Related Art

In an electrophotographic image forming apparatus, conventionally, a capacitance system is widely known as a toner remaining amount detecting unit for detecting a remaining amount of toner in a toner accommodating portion of a process cartridge or a toner cartridge. In the capacitance system, at least two electrodes are arranged in a toner accommodating portion to constitute a capacitor, and a change in capacitance between capacitor electrodes is detected to thereby detect the remaining amount of the toner. Of the two electrodes constituting the capacitor, a first electrode is supplied with an AC voltage, a second electrode is connected to a current detecting circuit, and a displacement current that flows through the capacitor due to the AC voltage is detected by the current detecting circuit, thereby detecting the remaining toner amount. As a capacitor electrode in the toner accommodating portion, a configuration in which a conductive sheet is fixed to a developer accommodating frame has been proposed (Japanese Patent Application Publication No. 2018-10277 and Japanese Patent Application Publication No. 2023-174061).

### SUMMARY

The present disclosure is directed to improve a cartridge or an electrophotographic image forming apparatus.

An image forming apparatus according to the present disclosure includes:
an apparatus body having a body contact; and
a cartridge detachably mountable to the apparatus body, the cartridge including a first unit having a photosensitive drum and a second unit having a developing roller for supplying toner to the photosensitive drum, and an electrical contact brought into contact with the body contact, the first unit and the second unit moving about a pivot axis between a contact position at which the photosensitive drum and the developing roller come into contact with each other and a spaced-apart position where the photosensitive drum and the developing roller are spaced apart from each other;
wherein, when viewed in a direction of the pivot axis,
in a case where a downstream-side end of the electrical contact is a first end and an upstream-side end of the electrical contact is a second end in a rotation direction about the pivot axis in a case where the second unit moves from the spaced-apart position to the contact position,
the body contact comes into contact with a region of the electrical contact between the first end and a midpoint of the first end and the second end in a case where the second unit is at the contact position, and
the body contact maintains contact with the electrical contact while the second unit moves between the spaced-apart position and the contact position, and
wherein in a case where a distance between the first end and the pivot axis is D1, a distance between the second end and the pivot axis is D2, and a distance between the midpoint and the pivot axis is Dc,
Dc≤D1 and Dc≤D2 are satisfied.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating a developing unit according to an embodiment of the present disclosure.

FIG. 2A is a cross-sectional view of a detection capacitor according to the embodiment of the present disclosure.

FIG. 2B is a cross-sectional view illustrating an electric field formed between a first electrode portion and a second electrode portion of the detection capacitor in the embodiment of the present disclosure.

FIG. 3 is a cross-sectional view of an image forming apparatus body.

FIG. 4 is a cross-sectional view of a process cartridge.

FIG. 5 is a perspective view of the process cartridge.

FIG. 6A is a perspective view of a remaining amount detection member including an electrode holder for holding a first electrode and a second electrode.

FIG. 6B is a perspective view of the remaining amount detection member from which the electrode holder is removed from the state illustrated in FIG. 6A.

FIG. 7A is a perspective view illustrating a positional relationship between the process cartridge and a laser scanner.

FIG. 7B is a perspective view illustrating the positional relationship between the process cartridge and the laser scanner, viewed from an angle different from that illustrated in FIG. 7A.

FIG. 8A is a perspective view of a frame member as viewed from below.

FIG. 8B is a perspective view of the frame member when a cover member is removed from FIG. 8A.

FIG. 9A is a perspective view of a second substrate, a substrate holder, a first spring, and a second spring.

FIG. 9B is a perspective view of the second substrate, the substrate holder, the first spring, and the second spring, viewed from an angle different from that in FIG. 9A.

FIG. 9C is a perspective view of the second substrate, the substrate holder, the first spring, and the second spring, viewed from an angle different from those of FIGS. 9A and 9B.

FIG. 10 is an explanatory diagram of the positional relationship among the developing unit, a first electrical contact, and a second electrical contact.

FIG. 11A is a cross-sectional view illustrating the manner in which a detection capacitor metal mold core is moved in a direction X4 relative to a detection capacitor metal mold cavity in the method of forming the detection capacitor by conductive two-color molding (primary molding).

FIG. 11B is a cross-sectional view illustrating the manner in which mold clamping is performed in a state where the detection capacitor metal mold core is abutted against the detection capacitor metal mold cavity in the method of forming the detection capacitor by the conductive two-color molding (primary molding).

FIG. 11C is a cross-sectional view illustrating the state where the electrode holder is formed by molding an insulating resin in the mold in the method of forming the detection capacitor by the conductive two-color molding (primary molding).

FIG. 12A is a cross-sectional view illustrating the manner in which a detection capacitor mold first core back portion and a detection capacitor mold second core back portion are moved in a direction X3 in the method of forming the detection capacitor by the conductive two-color molding (the secondary molding).

FIG. 12B is cross-sectional view illustrating the manner in which the detection capacitor is formed by in-mold forming a conductive resin in a first core back space of the detection capacitor mold and a second core back space of the detection capacitor mold formed by core back of the detection capacitor mold first core back portion and the detection capacitor mold second core back portion, in the method of forming the detection capacitor by the conductive two-color molding (secondary molding).

FIG. 13A is a cross-sectional view illustrating the manner in which the detection capacitor metal mold core is moved in a direction X3 after the detection capacitor is formed in the method of forming the detection capacitor by the conductive two-color molding (mold release).

FIG. 13B is a cross-sectional view illustrating the manner in which the detection capacitor moves in the direction X3 relative to the detection capacitor mold cavity in the method of forming the detection capacitor by the conductive two-color molding (mold release).

FIG. 14A is a front view illustrating the configuration of the remaining amount detection member.

FIG. 14B is a cross-sectional view taken along line A-A in a toner sealing configuration of FIG. 14A.

FIG. 14C is a cross-sectional view taken along line B-B in the toner sealing configuration of FIG. 14A.

FIG. 14D is a detailed view of the toner sealing configuration illustrated in FIG. 14B and FIG. 14C.

FIG. 15 is a cross-sectional view illustrating the configurations of the electrical contact and the developing contact.

FIG. 16A is a perspective view illustrating a flow passage of the conductive resin branching into a first electrode gate portion and a second electrode gate portion in the conductive resin molding.

FIG. 16B is a perspective view illustrating a first electrode flow passage and a second electrode flow passage that are conductive resin flow passages branching toward a longitudinal direction Z1 that is a side toward the electrical contact and a longitudinal direction Z2 that is a side toward the detection capacitor.

FIG. 17A is a perspective view illustrating the flow passage of the conductive resin on the longitudinal direction Z2 side, flowing into a part of the detection capacitor beyond a first electrode toner sealing portion and a second-electrode toner sealing portion in the molding of the conductive resin.

FIG. 17B is a perspective view illustrating that molding of the detection capacitor in the molding of the conductive resin is completed.

FIG. 18 is an explanatory diagram illustrating a result of capacitance simulation in the present embodiment and Comparative Example.

FIG. 19A is a cross-sectional view illustrating Comparative Example 1 of the detection capacitor with respect to the present embodiment.

FIG. 19B is a cross-sectional view illustrating Comparative Example 2 of the detection capacitor with respect to the present embodiment.

FIG. 20 is a block diagram of a wiring configuration of a high voltage circuit, a detection circuit, and the process cartridge.

FIG. 21 is an equivalent circuit diagram illustrating the structure of FIG. 20 with circuit constants.

FIG. 22A is a time-series explanatory diagram illustrating a pulsating waveform of a toner remaining amount detection signal which periodically changes by an amplitude ΔV at a time interval of a stirring period.

FIG. 22B is a time-series explanatory diagram illustrating the waveform of the toner remaining amount detection signal when a stray capacitance in a remaining amount detection circuit K becomes excessively high.

FIG. 22C is a time-series explanatory diagram illustrating the waveform of the toner remaining amount detection signal when a parasitic resistance in the remaining amount detection circuit is excessively high or the capacitance of the detection capacitor is excessively low.

FIG. 23A is a schematic cross-sectional view of the process cartridge when the developing unit is in the contact position.

FIG. 23B is a schematic cross-sectional view of the process cartridge when the developing unit is at a separation position (spaced-apart position).

### DESCRIPTION OF THE EMBODIMENTS

Hereinafter, aspects for carrying out the present disclosure will be illustratively described in detail based on embodiments with reference to the drawings. In this regard, the dimensions, materials, shapes, relative arrangements, and the like of the components described in the embodiments may be appropriately modified according to the configurations and various conditions of apparatuses to which the present disclosure is applied. That is, the scope of the present disclosure is not intended to be limited to the embodiments described below. While a plurality of features are described in each of the embodiments, all of the plurality of features are not necessarily essential to the present disclosure and the plurality of features may be combined with each other in any way. Moreover, in the accompanying drawings, the same reference numerals are assigned to the same or similar components, and redundant descriptions thereof are omitted.

Here, a developing unit refers to a unit that includes at least one of toner, a toner accommodating portion, a developer bearing member, and a process unit acting on the developer bearing member, and that is detachably attached to an electrophotographic image forming apparatus body (hereinafter, referred to as the “apparatus body”). Typical examples of the developing unit include a developing cartridge, a process cartridge, and a toner cartridge. The developing cartridge is a cartridge in which the developer bearing member and the process unit acting on the developer bearing member are integrated into a cartridge, and is removably mounted on the apparatus body. The process cartridge is a cartridge in which an image bearing member and a process unit acting on the image bearing member are integrated into a cartridge, and is removably mounted to the apparatus body. The toner cartridge accommodates a developer (hereinafter, referred to as a “toner”) to be supplied to a developing member such as a developer bearing member, and is removably mounted on the apparatus body. Moreover, the electrophotographic image forming apparatus uses an electrophotographic image forming system to form an image on a recording medium. Examples of electrophotographic image forming apparatuses include electrophotographic copying machines, electrophotographic printers (LED printers, laser beam printers, or the like), a facsimile apparatus, a word processor, and the like.

### First Embodiment

### Overall Overview of Image Forming Apparatus Body

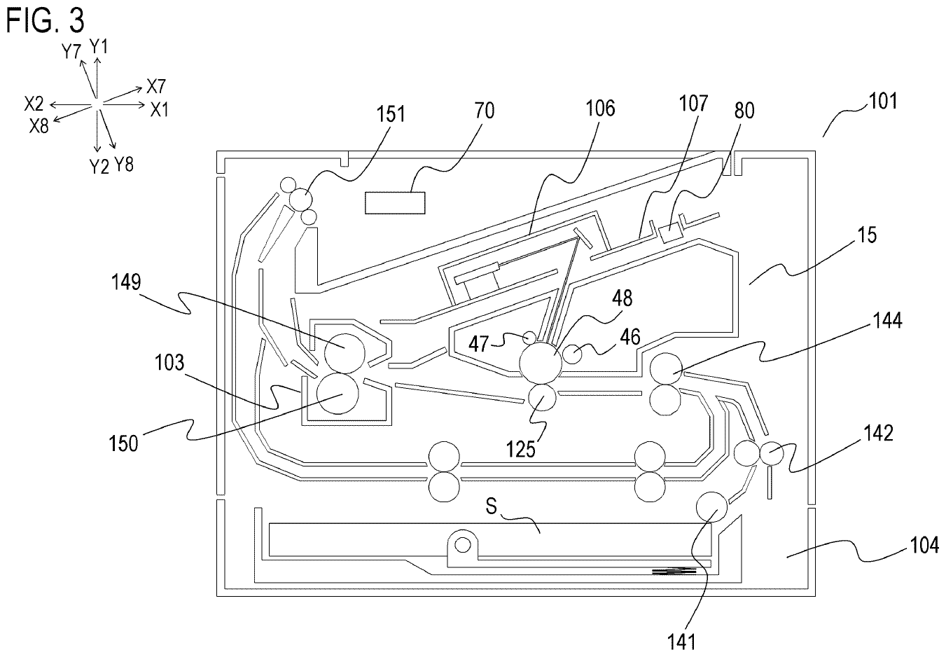

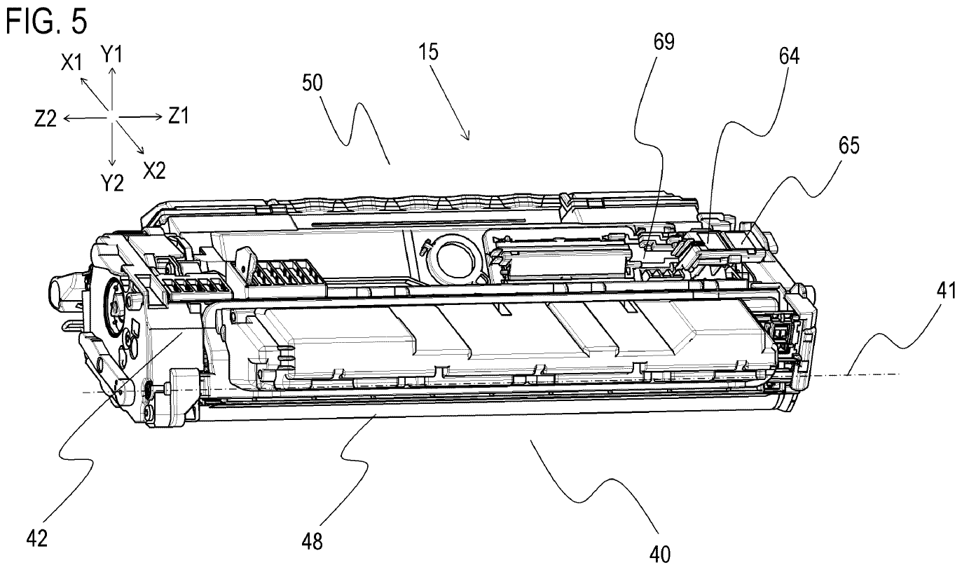

FIG. 3 is a cross-sectional view illustrating the schematic configuration of a monochromatic laser printer which is an example of an image forming apparatus. An image forming apparatus body (hereinafter, referred to as apparatus body 101) illustrated in FIG. 3 can be roughly divided into a sheet feeding portion, an image forming portion which forms an image on sheet, a fixing portion, a sheet discharge reversing portion, and a double-sided conveying portion. In an image forming posture of the apparatus body 101, a horizontal direction is denoted by X1, X2, and a vertical direction is denoted by Y1, Y2. As illustrated in FIG. 5, a direction perpendicular to the horizontal directions X1 and X2 and the vertical directions Y1 and Y2 is defined as longitudinal directions Z1 and Z2. The apparatus body 101 includes a process cartridge 15 that is detachably attached to the apparatus body 101. The process cartridge 15 is a process unit for forming a toner image on sheet S using the electrophotographic process, and has process units such as a photosensitive drum 48 as an image bearing member, a charging roller 47, and a developing roller 46 as a developer bearing member. Here, it is assumed that mounting directions of the process cartridge 15 with respect to the apparatus body 101 are X7 and X8, and the mounting vertical directions are Y7 and Y8.

A laser scanner 106 is disposed above the process cartridge 15 to perform exposure on the photosensitive drum 48 in accordance with an image signal. The photosensitive drum 48 is charged to a predetermined negative potential by the charging roller 47. Thereafter, the laser scanner 106 scans the photosensitive drum 48 with a laser beam, thereby forming an electrostatic latent image on the photosensitive drum 48. Thereafter, toner is supplied and developed from the developing roller 46 onto the photosensitive drum 48, and visualized as a toner image.

The sheet feeding portion includes a sheet feeding roller 141 attached to the apparatus body 101 and a sheet feeding cassette 104 detachably attached to the apparatus body 101. The sheets S accommodated in the sheet feeding cassette 104 are separated and fed one by one by a sheet feeding roller 141. The fed sheet S is conveyed to a pair of registration rollers 144 by a pair of conveyance rollers 142, skew correction is performed by the pair of registration rollers 144, and the sheet S is conveyed to the transfer portion.

In the transfer portion, a bias applying unit (not illustrated) applies a positive bias to a transfer roller 125. As a result, the toner image on the photosensitive drum 48 is transferred to the sheet S conveyed to the transfer portion.

The sheet S to which the toner image has been transferred is conveyed to a fixing apparatus 103 provided on the downstream side in the conveyance direction as viewed from the transfer portion. The fixing apparatus 103 fixes the toner image transferred to the sheet S to the sheet, and includes a heating unit 149 including a heater which is a heating member (not illustrated), and a pressure roller 150 which is a pressure member rotating in pressure contact with the heating unit. The sheet S on which the toner image is formed is nipped and conveyed by a nip portion formed by the heating unit 149 and the pressure roller 150, and the toner image is fixed to the surface of the sheet S by being applied with heat and pressure.

The sheet S to which the toner image is fixed is discharged to the outside of the image forming apparatus by a pair of paper discharge rollers 151.

### Overall Process Cartridge

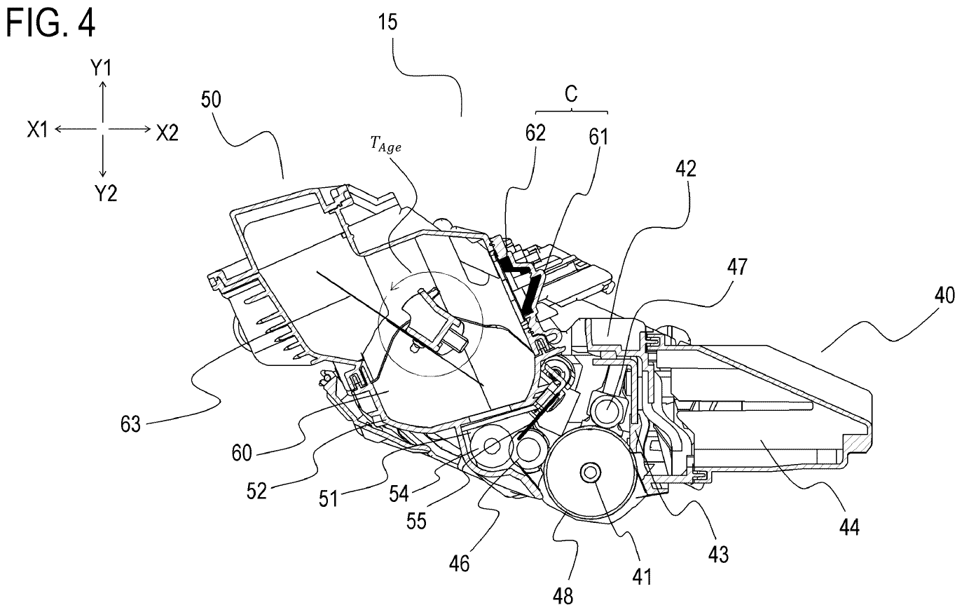

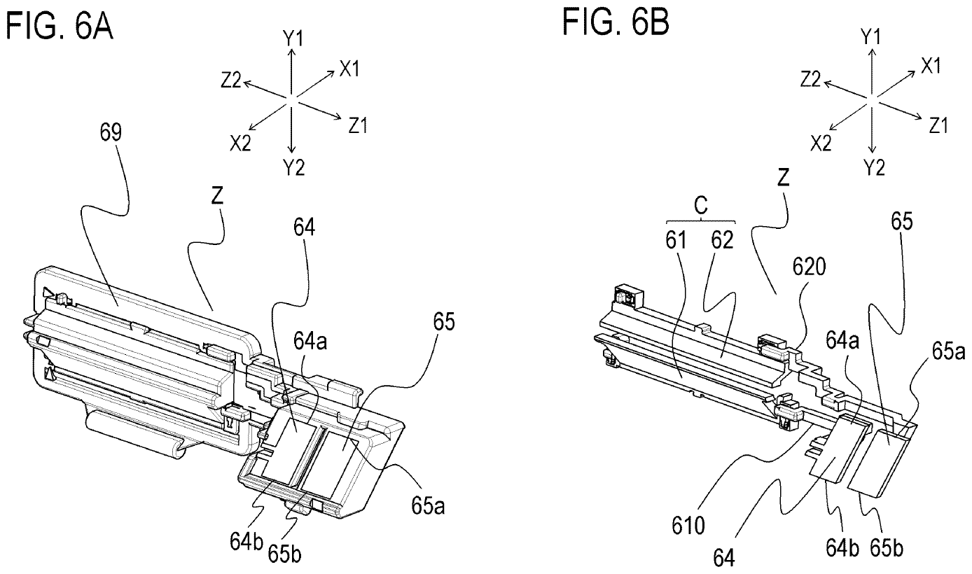

An overall configuration of the process cartridge 15 will be described with reference to FIGS. 4 to 6A and 6B. FIG. 4 is a cross-sectional view of the process cartridge 15, and FIG. 5 is a perspective view of the process cartridge 15. FIG. 6A is a perspective view of an electrode holder 69 for holding a first electrode 61 and a second electrode 62. FIG. 6B is a perspective view of a state in which the electrode holder 69 is removed from the state illustrated in FIG. 6A.

The process cartridge 15 includes a cleaning unit 40 having a photosensitive drum 48 and a developing unit 50 having the developing roller 46, and is detachably attached to the apparatus body 101.

The cleaning unit 40 includes the photosensitive drum 48, a drum support member 42 that rotatably supports the photosensitive drum 48 around a rotation shaft 41, a cleaning blade 43, and a waste toner accommodating portion 44. The photosensitive drum 48 is rotatably supported around a rotation shaft 41 by the drum support member 42. The charging roller 47 is disposed so as to be in contact with the outer peripheral surface of the photosensitive drum 48, and charges the photosensitive drum 48 by voltage application from the apparatus body 101. Further, the charging roller 47 rotates following the photosensitive drum 48. The tip of the cleaning blade 43 is in elastic contact with the photosensitive drum 48 to remove transfer residual toner (hereinafter, referred to as waste toner) remaining on the photosensitive drum 48 after the sheet S passes between the photosensitive drum 48 and the transfer roller 125. The removed waste toner is accommodated in the waste toner accommodating portion 44.

The developing unit 50 includes a developing chamber 51 in which the developing roller 46, a supply roller 54, and a developing blade 55 are arranged, and a toner accommodating portion 60 that supplies toner to the developing chamber 51. The developing roller 46 supplies toner to a developing zone of the photosensitive drum 48. Then, the developing roller 46 develops the electrostatic latent image formed on the photosensitive drum 48 using the toner (developer). The developing blade 55 comes into contact with the developing roller 46 to define the amount of toner adhering to the peripheral surface of the developing roller 46, and at the same time, applies triboelectric charging to the toner. The supply roller 54 rubs against the developing roller 46 to supply the toner in the developing chamber 51 to the developing roller 46, and scrapes the excess toner adhering to the developing roller 46. The developing blade 55 comes into contact with the peripheral surface of the developing roller 46 to define the amount of toner adhering to the peripheral surface of the developing roller 46. In addition, the triboelectric charging is applied to the toner.

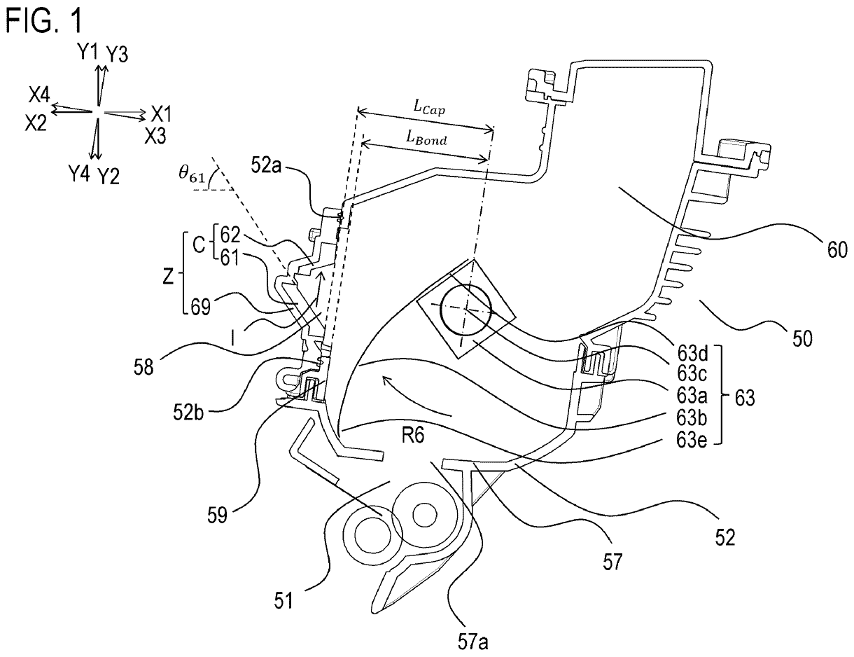

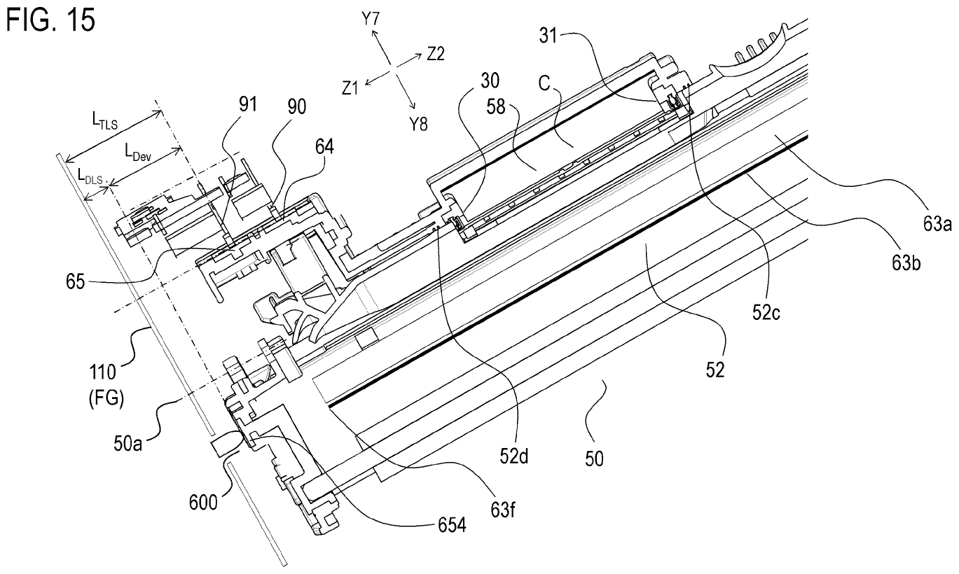

The toner accommodated in the toner accommodating portion 60 is sent to the developing chamber 51 by the rotation of the stirring member 63 and supplied to the developing roller 46. The toner accommodating portion 60 is provided with a detection capacitor C constituting capacitance. In the frame of the developing unit 50 constituting the toner accommodating portion 60, the first electrode 61 and the second electrode 62 used for detecting the capacitance inside the toner accommodating portion 60 are provided so as to be exposed to the toner accommodating portion 60. More specifically, the inner wall of the developing frame 52 forming the toner accommodating portion 60 includes a first wall surface 57 provided with an opening 57a that allows the toner accommodating portion 60 to communicate with the developing chamber 51, and a second wall surface 59 connected to the downstream of the first wall surface 57 in the rotation direction of the stirring member 63 (see FIG. 1). The second wall surface 59 as a part of the inner wall of the developing frame 52 is provided with a recess 58 that is recessed in a direction away from the rotation shaft (stirring shaft 63a to be described later) of the stirring member 63 in the direction (first direction) orthogonal to the longitudinal directions Z1 and Z2 (rotation axis of the stirring member 63) (see FIG. 1). The first electrode 61 and the second electrode 62 are provided in the recess 58. The width of the recess 58 in the longitudinal directions Z1 and Z2 (the second direction along the rotation axis of the stirring member 63) is defined by a first side wall 30 facing the same direction in the recess 58 and the second side wall 31 facing the first side wall 30 in the same direction (see FIG. 15). The first electrode 61 and the second electrode 62 are provided so as to extend in the longitudinal directions Z1 and Z2 between the first side wall 30 and the second side wall 31, respectively. In the rotation direction of the stirring member 63, the first electrode 61 is located on the upstream side, and the second electrode 62 is located on the downstream side. The first electrode 61 is provided so as to be gradually separated from the rotation shaft of the stirring member 63 from the upstream side toward the downstream side in the rotation direction of the stirring member 63. The second electrode 62 is provided so as to gradually approach the rotation shaft of the stirring member 63 from the upstream side to the downstream side in the rotation direction of the stirring member 63. The detection capacitor C is formed of the first electrode 61 and the second electrode 62, and is disposed substantially parallel to the longitudinal directions Z1 and Z2. The rotation of the stirring member 63 causes the toner to move in and out between the first electrode 61 and the second electrode 62. Due to the toner flowing in and out of the detection capacitor C, the capacitance between the first electrode 61 and the second electrode 62 changes according to a rotation period T_{Age} (hereinafter, referred to as a stirring period T_{Age}) of the stirring member 63.

As illustrated in FIG. 6A, a first electrical contact 64 and a second electrical contact 65 for making contact with a spring (not illustrated) on the apparatus body side described later are exposed from the electrode holder 69. As illustrated in FIG. 6B, the first electrode 61 and the first electrical contact 64 in the developing unit 50 are configured to be electrically connected by being integrally molded with a conductive resin. Similarly, the second electrode 62 and the second electrical contact 65 in the developing unit 50 are configured to be electrically connected by being integrally molded with a conductive resin. More specifically, the frame of the developing unit 50 includes an insulating portion having insulating properties and a conductive portion having conductivity. The latter conductive portion is integrally molded with the former insulating portion so as to be exposed to the inside (toner accommodating portion 60) and the outside of the frame. The conductive portion includes a first conductive portion in which a portion exposed to the toner accommodating portion 60 is the first electrode 61, and a portion exposed to the outside of the frame is the first electrical contact 64, and a second conductive portion in which a portion exposed to the toner accommodating portion 60 is the second electrode 62, and a portion exposed to the outside of the frame is the second electrical contact 65. In addition, the insulating portion is divided into a portion (first insulating portion) that pivotally supports the stirring member 63 and the like and a portion (second insulating portion) that is configured separately from the portion and is integrally molded with the conductive portion, and the former portion is the developing frame 52 and the latter portion is the electrode holder 69.

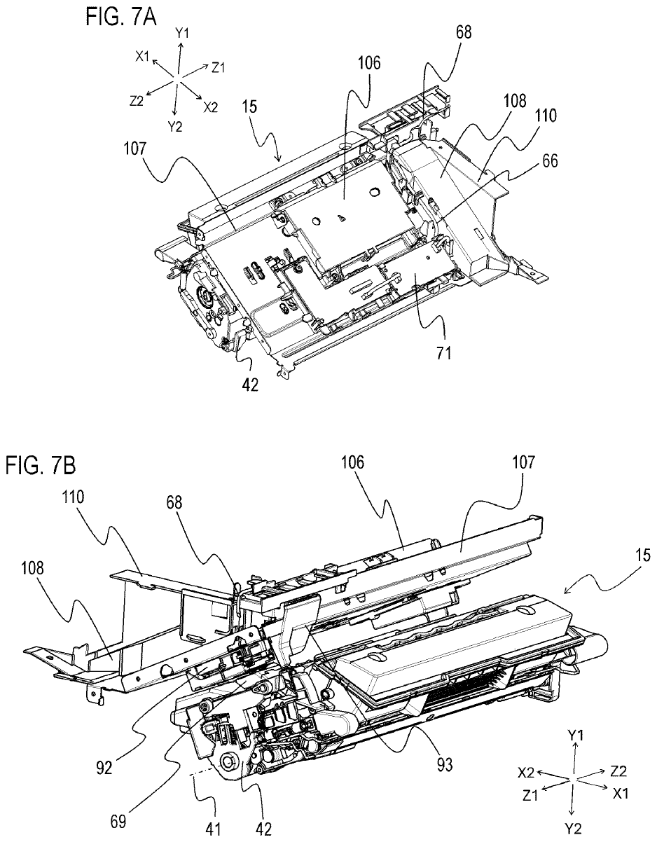

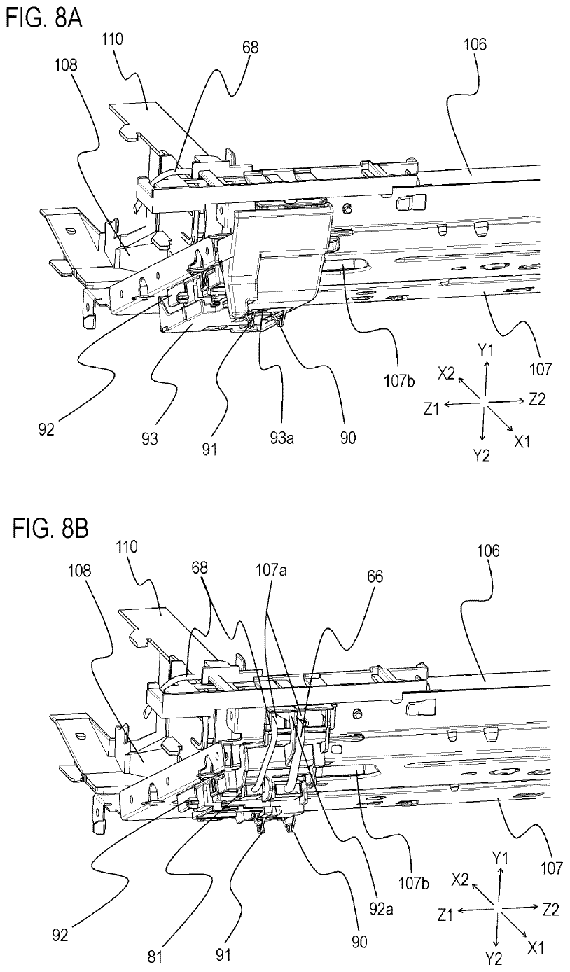

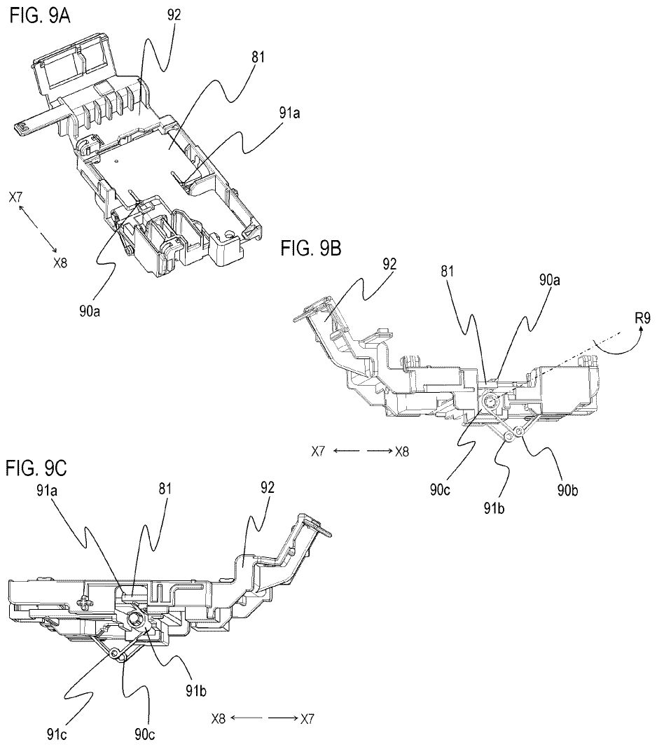

Next, the configuration of the apparatus body 101 according to the present embodiment will be described in detail with reference to FIGS. 7A and 7B to 9A to 9C. FIGS. 7A and 7B are perspective views illustrating a positional relationship between the process cartridge 15 and the laser scanner 106. FIG. 8A is a perspective view of the frame member 107 as viewed from below, and FIG. 8B is a view in which a cover member 93 is removed from FIG. 8A. FIGS. 9A to 9C are perspective views of a second substrate 81, a substrate holder 92, a first spring 90, and a second spring 91.

As illustrated in FIGS. 7A and 7B, the laser scanner 106 disposed above the process cartridge 15 in the direction of gravity is fixed to the metal frame member 107 disposed between the laser scanner 106 and the process cartridge 15. By fixing the laser scanner 106 to the metal frame member 107, the process cartridge 15 and the laser scanner 106 can be arranged with high rigidity and high accuracy. The first substrate 71 including an AC voltage output circuit is fixed above the frame member 107. Moreover, the second substrate 81 (see FIG. 8B) including a current detecting circuit is disposed below the frame member 107, and the second substrate 81 is held by the substrate holder 92. The first substrate 71 and the second substrate 81 are electrically connected by a cable (AC voltage line) 66. The second substrate 81 will be described later. A duct 108 for cooling the photosensitive drum 48 is provided on the frame member 107. The cable (AC voltage line) 66 is routed along the duct 108 and is connected to the second substrate 81 through a hole 107a provided in the frame member 107 as illustrated in FIG. 8B. The second substrate 81 and an engine controller (not illustrated) are connected by a cable (signal line) 68, and the cable (signal line) 68 is routed through the hole 107a of the frame member similarly to the cable (AC voltage line) 66.

As illustrated in FIGS. 8B and 9A to 9C, the substrate holder 92 also holds the first spring 90 and the second spring 91 (hereinafter, referred to as an electrical contact spring). The electrical contact springs 90 and 91 are torsion springs, and the fixed end sides 90a and 91a are in contact with the second substrate 81. The free end sides 90b and 91b of the electrical contact springs 90 and 91 are in contact with the first electrical contact 64 and the second electrical contact 65 provided in the developing unit 50 at a predetermined pressure. Coil portions 90c and 91c of the torsion springs are disposed on the upstream side of the contact portions 90b and 91b between the first electrical contact 64 and the second electrical contact 65 on the free end side with respect to the insertion direction of the process cartridge 15, and rotate in a torsion spring rotation direction R9 illustrated in FIG. 9B in accordance with the insertion of the process cartridge 15. As illustrated in FIG. 8A, the substrate holder 92, the first spring 90, and the second spring 91 are covered with the cover member 93, and the contact portions 90b and 91b on the free end side of the first spring 90 and the second spring 91 are configured to be exposed through the holes 93a provided in the cover member 93. The contact portions 90b and 91b have a shape wound in a single rotation coil shape.

### Toner Remaining Amount Detection Circuit

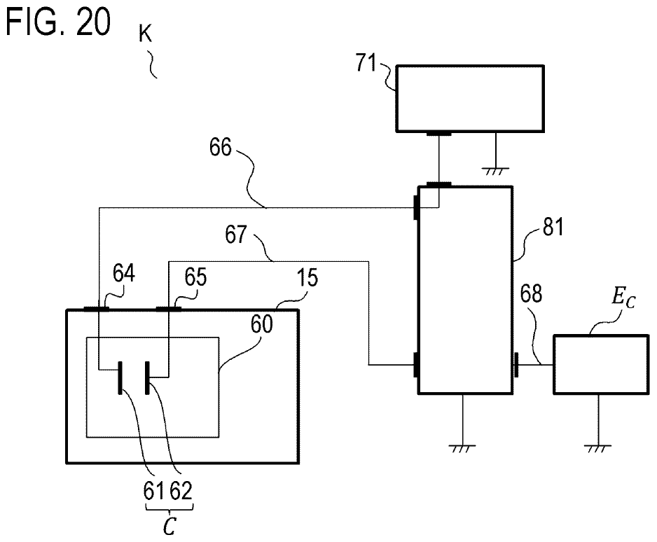

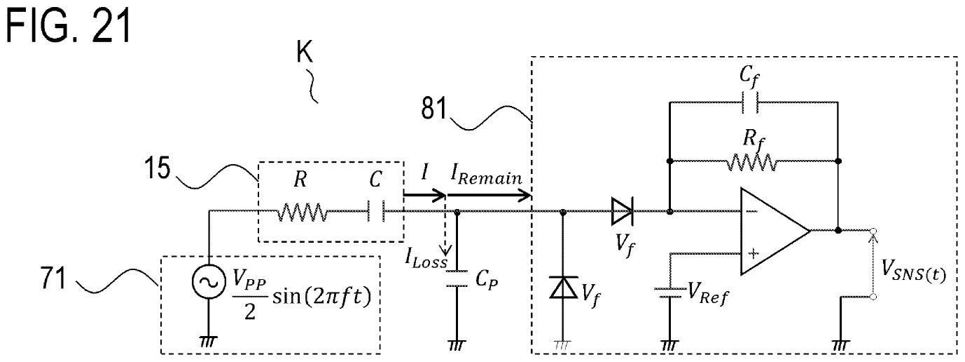

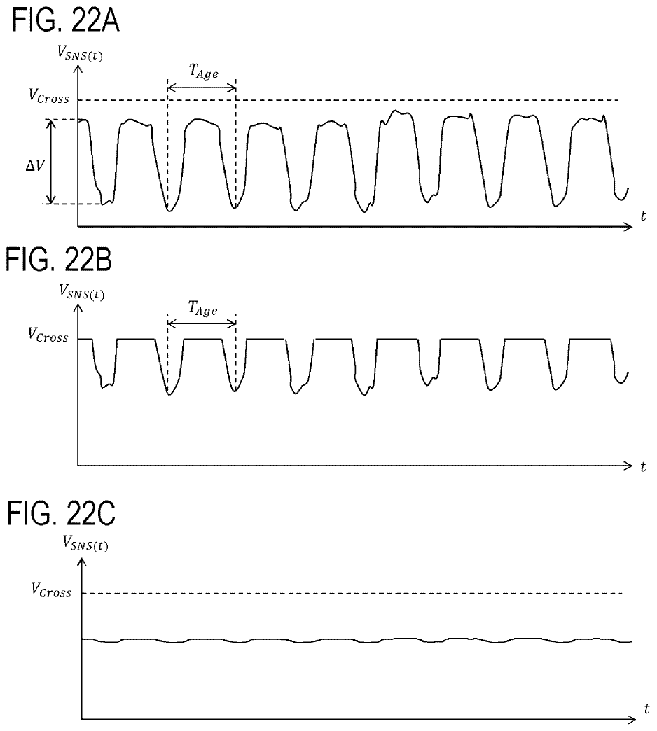

The configuration of a toner remaining amount detection circuit K (hereinafter, referred to as a remaining amount detection circuit K) and the toner remaining amount detection signal V_{(SNS(t))} (hereinafter, referred to as a remaining amount detection signal V_{(SNS(t))}) obtained from the remaining amount detection circuit K in the embodiment of the present disclosure will be described with reference to FIGS. 9A to 9C, 20, 21, and 22A to 22C. FIG. 20 is a block diagram illustrating a wiring configuration among the first substrate 71, the second substrate 81, and the process cartridge 15 in the remaining amount detection circuit K. FIG. 21 is an equivalent circuit diagram in which each element of the remaining amount detection circuit K is represented by an electric circuit constant. FIGS. 22A to 22C are time-series diagrams illustrating the remaining amount detection signal V_{(SNS(t))} obtained from the remaining amount detection circuit K.

As illustrated in FIG. 20, the remaining amount detection circuit K includes the first substrate 71 (AC voltage output circuit), the process cartridge 15, and the second substrate 81 (current detecting circuit). The first substrate 71 is electrically connected to the first electrode 61 located on one end side of the detection capacitor C provided in the process cartridge 15 via the cable (AC voltage line) 66 and the first electrical contact 64. The second electrode 62 on the other end side of the detection capacitor C is electrically connected to the second substrate 81 via the second electrical contact 65 and the remaining amount detection signal line 67. The second substrate 81 is electrically connected to an engine controller E_{C} via a cable (signal line) 68.

As illustrated in FIG. 21, the first substrate 71 is an AC voltage output circuit including an AC power supply, and applies an AC voltage of (V_{PP}/2)sin(2πft) to the process cartridge 15. Here, V_{PP} is the amplitude of the AC voltage, f is the frequency of the AC voltage, π is the circular constant, and t is the elapsed time. The second substrate 81 includes a half-wave rectifier unit including two half-wave rectifier diodes V_{f} and a primary low-pass filter. The primary low-pass filter includes an operational amplifier driven with a reference voltage V_{Ref}, a detection sensitivity resistor R_{f} for current-voltage conversion, and a cutoff capacitor C_{f} for noise suppression.

The AC voltage input to the process cartridge 15 is output as a displacement current I to the second substrate 81 side via a parasitic resistance R existing between the electrical contact springs 90 and 91 illustrated in FIGS. 9A to 9C and the electrical contacts 64 and 65 illustrated in FIG. 20, and via the detection capacitor C. Since the displacement current I is affected by a stray capacitance C_{P} generated between a frame GND and the wiring of another circuit, a part of the displacement current I flows out of the remaining amount detection circuit K as the displacement current loss component I_{Loss}. As a result, an effective displacement current component I_{Remain}, which is a residual between the displacement current I and the displacement current loss component I_{Loss}, is input to the second substrate 81. The effective displacement current component I_{Remain} input to the second substrate 81 is half-wave rectified through the half-wave rectifier unit, and then output as a remaining amount detection signal V_{(SNS(t))} by a current-voltage converting action of the primary low-pass filter. When Ohm's law and Kirchhoff's law are applied to the equivalent circuit illustrated in FIG. 21 and the remaining amount detection signal V_{(SNS(t))} is solved, the following equation is obtained.

$${V}_{SHS ( t )} = {V}_{Ref} - {R}_{f} \{ \frac{\frac{1}{2} ( \frac{{V}_{PP}}{π} - {V}_{f} )}{R + \frac{1}{2 π fC}} - π {fV}_{f} {C}_{P} \}$$

As described above, the capacitance of the detection capacitor C periodically changes at the time interval of the stirring period T_{Age} due to the entrance and exit of the toner to and from the detection capacitor C. Therefore, as illustrated in FIG. 22A, the remaining amount detection signal V_{(SNS(t))} has a pulsating waveform that periodically changes by the amplitude ΔV at time intervals of the stirring period T_{Age}. The remaining amount detection signal V_{(SNS(t))} is subjected to digital signal processing by the engine controller E_{C} to calculate the amplitude ΔV and the Duty. A correlation between the amplitude ΔV and the Duty and the toner remaining amount in the process cartridge 15 is acquired in advance according to the form of the process cartridge 15, and the toner remaining amount is estimated by collating with the amplitude ΔV and the Duty calculated at the time of product use.

According to the above equation, when the stray capacitance C_{P} in the remaining amount detection circuit K becomes excessively high, the remaining amount detection signal V_{(SNS(t))} exceeds an allowable detection voltage V_{Cross} as illustrated in FIG. 22B, and thus, the remaining amount detection signal V_{(SNS(t))} is clipped, so that it is difficult to accurately detect the toner remaining amount. Therefore, the stray capacitance C_{P} is reduced by providing a sufficient gap between the wiring from the detection capacitor C to the second substrate 81, that is, the conduction path from the second electrode 62 to the second electrical contact 65 and by the remaining amount detection signal line 67, and the wiring of the frame GND and another circuit. In addition, according to the above equation, in a case where the parasitic resistance R in the remaining amount detection circuit K is excessively high or the capacitance of the detection capacitor C is excessively low, the amplitude ΔV of the remaining amount detection signal V_{(SNS(t))} cannot be sufficiently obtained as illustrated in FIG. 22C, so that accurate toner remaining amount detection cannot be performed. Therefore, the capacitance of the detection capacitor C is sufficiently secured while suppressing the parasitic resistance R generated between the conduction path from the first electrical contact 64 to the first electrode 61 and the conduction path from the second electrode 62 to the second electrical contact 65.

### Arrangement Configuration of Electrical Contact

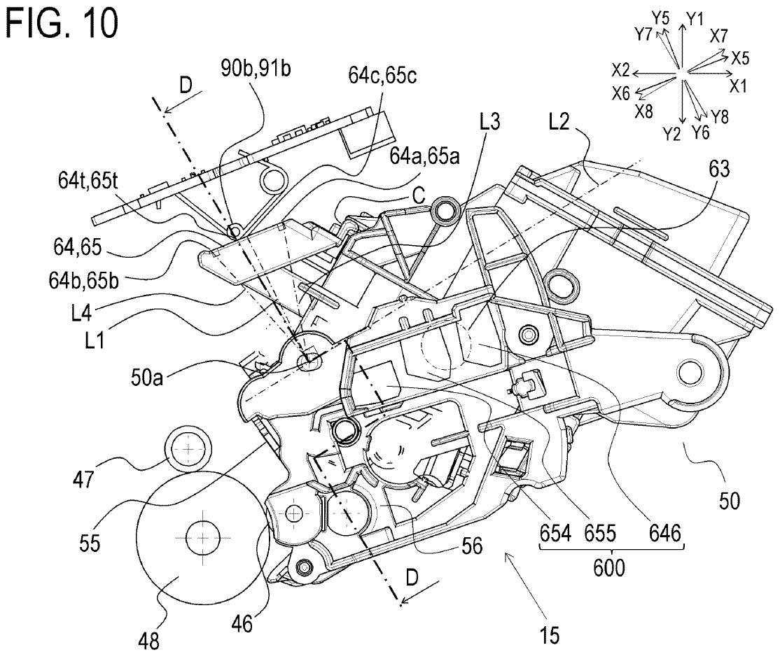

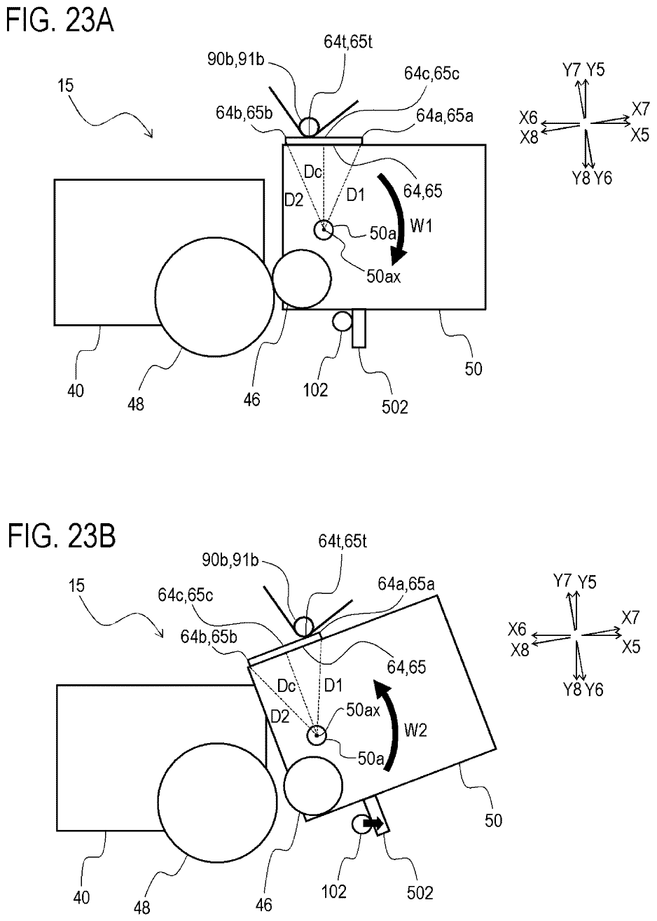

An arrangement configuration of the electrical contacts 64 and 65 will be described with reference to FIGS. 6A, 6B, 10, 23A, and 23B. FIG. 10 is a side view illustrating a positional relationship between the developing unit 50 and the electrical contacts 64 and 65. As illustrated in FIG. 10, the developing unit 50 is provided with a developing contact 600 for supplying a predetermined bias to each of the developing roller 46, the supply roller 54, and the developing blade 55. The developing contact 600 includes a developing roller contact 646 that supplies a bias to the developing roller 46, a supply roller contact 654 that supplies a bias to the supply roller 54, and a developing blade contact 655 that supplies a bias to the developing blade 55. The developing unit 50 is rotatably supported pivotably around a pivot center 50a (around a pivot axis) of the developing unit provided in the process cartridge 15. As a result, in a state where the process cartridge is attached to the apparatus body 101 illustrated in FIG. 3, the developing unit 50 can take a contact state in which the developing roller 46 is in contact with the photosensitive drum 48 and a separated state in which the developing roller 46 is separated from the photosensitive drum 48. Switching between the contact state and the separated state is performed when the developing unit 50 rotates around the pivot center 50a by receiving pressing from a developing/separating mechanism (see FIGS. 23A and 23B) provided in the apparatus body 101. Meanwhile, the rotation shaft centers of the photosensitive drum 48 and the charging roller 47 are fixed in a state of being attached to the apparatus body 101. By switching to the separated state at the time of non-use after completion of the image forming operation while performing toner development on the photosensitive drum 48 in the contact state during the image forming operation, the contact pressure of the developing roller 46 with respect to the photosensitive drum 48 can be released, so that the life of the developing roller 46 can be extended.

The electrical contacts 64 and 65 are in contact with the free end sides 90b and 91b of the electrical contact springs 90 and 91 at a first electrical contact portion 64t and a second electrical contact portion 65t (hereinafter, referred to as an electrical contact portion). The electrical contacts 64 and 65 are formed as surfaces (contact surfaces) including lines connecting a first electrical contact first end 64a and a second electrical contact first end 65a (hereinafter, referred to as an electrical contact first end), and a first electrical contact second end 64b and a second electrical contact second end 65b (hereinafter, referred to as an electrical contact second end). Here, midpoints of the electrical contact first ends 64a and 65a and the electrical contact second ends 64b and 65b are defined as a first electrical contact center portion 64c and a second electrical contact center portion 65c (hereinafter, referred to as an electrical contact center portion), respectively. In addition, a line segment connecting the electrical contact center portions 64c and 65c and the pivot center 50a is defined as a first line L1, and a line segment perpendicular to the first line L1 and passing through the pivot center 50a is defined as a second line L2.

Subsequently, axial directions passing through the electrical contact first ends 64a and 65a and the electrical contact second ends 64b and 65b are defined as electrical contact parallel directions X5 and X6, and axial directions perpendicular to the electrical contact parallel directions X5 and X6 are defined as electrical contact vertical directions Y5 and Y6. Further, a line segment passing through the electrical contact first ends 64a and 65a and the pivot center 50a is defined as a third line L3, and a line segment passing through the electrical contact second ends 64b and 65b and the pivot center 50a is defined as a fourth line L4.

In the present embodiment, an angle formed by the electrical contact parallel directions X5 and X6 and the mounting directions X7 and X8 of the process cartridge 15 is 15° or less. From the viewpoint of reduction in size of the apparatus body 101 and suppression of contact wear due to fluctuation in electrical contact pressure at the time of mounting the process cartridge 15, the above angle is reduced as much as possible. In addition, the electrical contact portions 64t and 65t are arranged so as to be close to the electrical contact center portions 64c and 65c. This is from the viewpoint of securing the amount of engagement between the electrical contacts 64 and 65 and the free end sides 90b and 91b of the electrical contact springs 90 and 91 in consideration of component tolerance and creep deformation due to being left for a long period of time.

The first line L1 in the present embodiment is provided to satisfy the following equations with respect to the third line L3 and the fourth line L4.

$$L 1 \leq L 3 and L 1 \leq L 4$$

Thus, when the inclinations of the contact surfaces of the electrical contacts 64 and 65 satisfy L3<L1<L4 or L3>L1>L4, wear of the electrical contacts 64 and 65 due to fluctuation of the contact pressure at the time of switching between the contact state and the separated state of the developing unit 50 is suppressed, and the life of the product can be prolonged. In addition, since it is possible to suppress an increase in contact resistance due to the wear of the electrical contacts 64 and 65, it is possible to prevent an increase in parasitic resistance which is a factor of attenuation of the remaining amount detection signal V_{(SNS(t))}. As a result, the toner remaining amount detection accuracy can be secured by stabilizing the remaining amount detection signal V_{(SNS(t))} throughout the product life.

In the present embodiment, the contact surfaces of the electrical contacts 64 and 65 are formed to have a planar shape satisfying L1<L3 and L1<L4, but the contact surfaces can alternatively be formed in an arc shape centered on the pivot center 50a satisfying L1=L3 and L1=L4. The shape of the contact surfaces of the electrical contacts 64 and 65 is formed in a planar shape from the viewpoint of cost reduction and inspection due to simplification of the shape.

A change in the contact state between the electrical contacts 64 and 65 and the electrical contact springs 90 and 91 (first and second main body contacts) will be described with reference to schematic diagrams illustrated in FIGS. 23A and 23B. FIG. 23A is a schematic diagram of the process cartridge 15 when the developing unit 50 is in the contact position, and FIG. 23B is a schematic diagram of the process cartridge 15 when the developing unit 50 is in the separation position (spaced-apart position). As described above, the process cartridge 15 includes the cleaning unit 40 (first unit) including the photosensitive drum 48 and the like, and the developing unit 50 (second unit) including the developing roller 46 and the like. The cleaning unit 40 and the developing unit 50 are configured to be relatively movable about a pivot axis 50ax (pivot center 50a) to a contact position where the photosensitive drum 48 and the developing roller 46 are in contact with or in proximity to each other and the separation position (spaced-apart position) where the photosensitive drum 48 and the developing roller 46 are separated (spaced-apart) from each other. In the present embodiment, the pressing portion 102 provided in the apparatus body 101 presses the pressed portion 502 provided in the developing unit 50 in a predetermined pressing direction, so that the developing unit 50 rotates in a W2 direction about the pivot center 50a and moves from the contact position to the separation position (FIG. 23B). In addition, in a state where the pressing portion 102 does not press the pressed portion 502, the developing unit 50 rotates in the W1 direction about the pivot center 50a by the biasing force of a biasing member (not illustrated) such as a spring provided between the cleaning unit 40 and the developing unit 50 (FIG. 23A). Accordingly, the developing unit 50 moves from the separation position to the contact position, and the photosensitive drum 48 and the developing roller 46 come into contact with each other. The configuration of the contact/separation is not limited thereto, and the contact/separation may be performed by moving the cleaning unit 40. The electrical contact springs 90 and 91 maintain contact with the electrical contacts 64 and 65 while the developing unit 50 moves between the separation position and the contact position. The electrical contact springs 90 and 91 come into contact with the electrical contacts 64 and 65 at positions between the electrical contact first ends 64a and 65a and the electrical contact center portions 64c and 65c when the developing unit 50 is in the contact position. When the developing unit 50 is in the separation position, the electrical contact springs 90 and 91 come into contact with the electrical contacts 64 and 65 at a position between the electrical contact center portions 64c and 65c and the electrical contact second ends 64b and 65b.

Here, a line segment connecting the electrical contact first ends 64a and 65a and the pivot center 50a (pivot center 50a), that is, a distance between the electrical contact first ends 64a and 65a and the pivot center 50a when viewed in the direction of the pivot axis 50ax is defined as D1. The electrical contact first ends 64a and 65a are downstream-side ends of the electrical contacts 64 and 65 in the rotation direction W1 (FIG. 23A) around the pivot axis 50ax when the developing unit 50 moves from the separation position to the contact position. Similarly, a line segment connecting the electrical contact second ends 64b and 65b and the pivot center 50a (pivot center 50a), that is, a distance between the electrical contact second ends 64b and 65b and the pivot center 50a is defined as D2. The electrical contact second ends 64b and 65b are the upstream-side ends of the electrical contacts 64 and 65 in the rotation direction W1 (FIG. 23A) around the pivot axis 50ax when the developing unit 50 moves from the separation position to the contact position. Similarly, a line segment connecting the electrical contact center portions 64c and 65c and the pivot axis 50ax (pivot center 50a), that is, a distance between the electrical contact center portions 64c and 65c and the pivot axis 50ax (pivot center 50a) is defined as Dc. The electrical contact center portions 64c and 65c are midpoints between the electrical contact first ends 64a and 65a and the electrical contact second ends 64b and 65b. In this case, Dc is configured to satisfy the following relationship with D1 and D2 (D1 corresponds to the length of the line segment of the third line L3 in FIGS. 9A to 9C, and D2 corresponds to the length of the line segment of the fourth line L4 in FIGS. 9A to 9C).

$$Dc \leq D 1 and Dc \leq D 2$$

By satisfying the above relationship, the fluctuation range of the contact pressure can be narrowed, and wear of the contact can be suppressed. The attachment/detachment directions X7 and X8 of the process cartridge 15 with respect to the apparatus body 101 are directions orthogonal to the pivot axis 50ax, and are substantially orthogonal to the line Lc when viewed in the direction of the pivot axis 50ax. In the first electrical contact 64 and the second electrical contact 65 arranged in the direction of the pivot axis 50ax, the contact surfaces with the electrical contact springs 90 and 91 are flat surfaces parallel to the pivot axis 50ax, and the normal direction thereof includes an upward component in the vertical direction when viewed in the direction of the pivot axis 50ax. As long as the above relationship is satisfied, the first electrical contact 64 and the second electrical contact 65 may be, for example, curved surfaces instead of flat surfaces.

### Arrangement Configuration of Electrical Contact and Developing Contact

The developing roller 46 and the supply roller 54 are rotatably and axially supported by a developing bearing 56 provided in the developing unit 50. Inside the developing bearing 56, the developing contact 600 and power supply passages from the developing contact 600 to the developing roller 46, the supply roller 54, and the developing blade 55 are provided by two-color molding of a conductive resin. The developing contact 600, that is, the developing roller contact 646, the supply roller contact 654, and the developing blade contact 655 are electrically connected to the developing roller 46, the supply roller 54, and the developing blade 55 via the respective power supply passages. The developing contact 600 may be formed by two-color molding of a conductive resin integrated with each power supply passage, or may be provided separately from each power supply passage using a metal sheet metal.

The electrical contacts 64 and 65 of the present embodiment are arranged to face the developing contact 600, the developing roller 46, the supply roller 54, and the developing blade 55 with the second line L2 as a boundary. In the image forming posture of the process cartridge 15, the electrical contacts 64 and 65 are disposed above the developing contact 600 in the vertical direction Y1. In addition, the normal direction of the electrical contacts 64 and 65 is provided to face the electrical contact vertical direction Y5, and the vertical component of the electrical contact vertical direction Y5 coincides with the vertical direction Y1.

In the present embodiment, as illustrated in FIGS. 10 and 20, the remaining amount detection circuit K including the electrical contacts 64 and 65 and the detection capacitor C is disposed to be the first phase, and the developing circuit including the developing contact 600, the developing roller 46, the supply roller 54, and the developing blade 55 is disposed to be the second phase separate from the first phase. Therefore, it is possible to prevent clipping of the remaining amount detection signal V_{(SNS(t))} due to the stray capacitance C_{P} between the remaining amount detection circuit and the development circuit, so that it is possible to accurately detect the toner remaining amount using the capacitance system. From the viewpoint of suppressing the stray capacitance C_{P}, the electrical contacts 64 and 65 are arranged as far as possible from the developing contact 600, and it is desirable to secure a distance between wirings of 5 mm or more in the overall power supply passage of the remaining amount detection circuit K and the developing circuit. In addition, the normal line of the developing contact 600 of the present embodiment is arranged in the longitudinal direction Z1, that is, on the outer side in the longitudinal direction with respect to the process cartridge 15. Meanwhile, the electrical contacts 64 and 65 are provided above the developing contact 600 in the vertical direction Y1, and the vertical component of the electrical contact vertical direction Y5, which is the normal direction of the electrical contacts 64 and 65, coincides with the vertical direction Y1. Therefore, in the construction space on the horizontal direction X1-vertical direction Y1 coordinate system, which is an arbitrary cross section of the process cartridge 15, the electrical contacts 64 and 65 and the developing contacts 600 are separately arranged with different normal directions. As a result, the electrical contacts 64 and 65 and the developing contact 600 can secure a sufficient arrangement space in consideration of the component tolerance. As a result, at the time of attachment to the apparatus body 101, the electrical contacts 64 and 65 and the developing contact 600 can perform stable electrical connection without interfering with each other. In addition, the normal lines of the electrical contacts 64 and 65 and the developing contact 600 are arranged in directions different from the vertical direction Y2 side which is the downward direction in the gravity direction. For example, there is a case where the process cartridge 15 is taken out from the apparatus body 101 for a reason such as jam handling at the time of using the apparatus body 101 and then placed on another place such as a desk or a workbench. Even in such a case, it is possible to suppress the risk of damage such as dents and scratches on the electrical contacts 64 and 65 and the developing contact 600.

Next, an arrangement configuration of the electrical contacts 64 and 65 and the developing contacts 600 in the longitudinal directions Z1 and Z2 will be described with reference to FIG. 15. FIG. 15 is a cross-sectional view taken along line D-D in the electrical contacts 64 and 65 and the developing contact 600 in FIG. 10. As illustrated in FIG. 15, the supply roller contact 654 which is a part of the developing contact 600 is provided at an end portion of the developing unit 50 on the longitudinal direction Z1 side. The developing roller contact 646 and the developing blade contact 655, which are other developing contacts, also have the same longitudinal arrangement as the supply roller contact 654. The second electrical contact 65 and the second spring 91 are arranged to face the developing contact 600 with an interval of a longitudinal distance L_{Dev} between the electrical contact and the developing contact in the longitudinal directions Z1 and Z2. In addition, the second electrical contact 65 and the second spring 91 are arranged to face a left plate 110 which is the frame ground FG with an interval of a longitudinal distance LTLS between the electrical contact and the left plate. The developing contact 600 is arranged to face the left plate 110 with an interval of a longitudinal distance LDLS between the developing contact and the left plate, which is a difference between the longitudinal distance LTLS between the electrical contact and the left plate and the longitudinal distance L_{Dev} between the electrical contact and the developing contact.

The longitudinal distance LTLS between the electrical contact and the left plate and the longitudinal distance L_{Dev} between the electrical contact and the developing contact are longer than the longitudinal distance LDLS between the developing contact and the left plate. Therefore, it is possible to prevent clipping of the remaining amount detection signal V_{(SNS(t))} due to the stray capacitance C_{P} between the remaining amount detection circuit K and the developing circuit and between the remaining amount detection circuit K and the left plate 110 also from the viewpoint of the longitudinal directions Z1 and Z2. Therefore, it is possible to accurately detect the toner remaining amount using the capacitance system.

### Method of Manufacturing Remaining Amount Detection Member Z

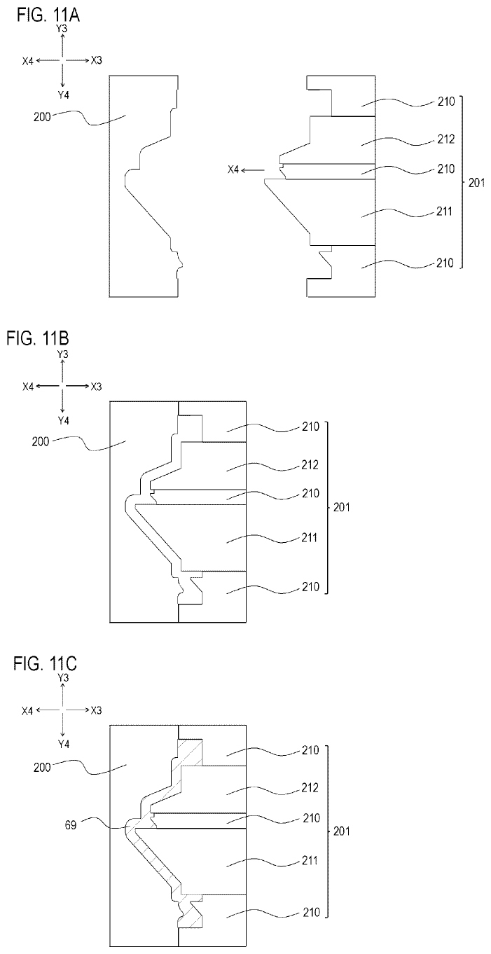

A method of manufacturing the remaining amount detection member Z including the detection capacitor C and the electrode holder 69 will be described with reference to FIG. 1 and FIGS. 11A to 11C to 13A and 13B. FIG. 1 is a cross-sectional view illustrating the configurations of the developing unit 50 and the detection capacitor C. FIGS. 11A to 11C to 13A and 13B are cross-sectional views illustrating a method of forming the remaining amount detection member Z by conductive two-color molding.

As illustrated in FIGS. 11A to 11C to 13A and 13B, the detection capacitor C is injection-molded by a detection capacitor mold cavity 200 which is a fixing-side mold and a detection capacitor mold core 201 which is a movable-side mold. The detection capacitor mold core 201 includes a detection capacitor mold core base portion 210, a detection capacitor mold first core back portion 211, and a detection capacitor mold second core back portion 212. The detection capacitor mold first core back portion 211 and the detection capacitor mold second core back portion 212 are configured to be capable of being translated with respect to the detection capacitor mold core base portion 210 in the detection capacitor nearest vertical directions X3 and X4 which are clamping directions.

First, as illustrated in FIG. 11A, the detection capacitor mold core 201 is moved in the detection capacitor nearest vertical direction X4 with respect to the detection capacitor mold cavity 200, and as illustrated in FIG. 11B, the detection capacitor mold core 201 abuts against the detection capacitor mold cavity 200. When the mold clamping is performed in this state and the insulating resin as the first material for molding is molded in the mold, the electrode holder 69 is formed (primary molding) as illustrated in FIG. 11C.

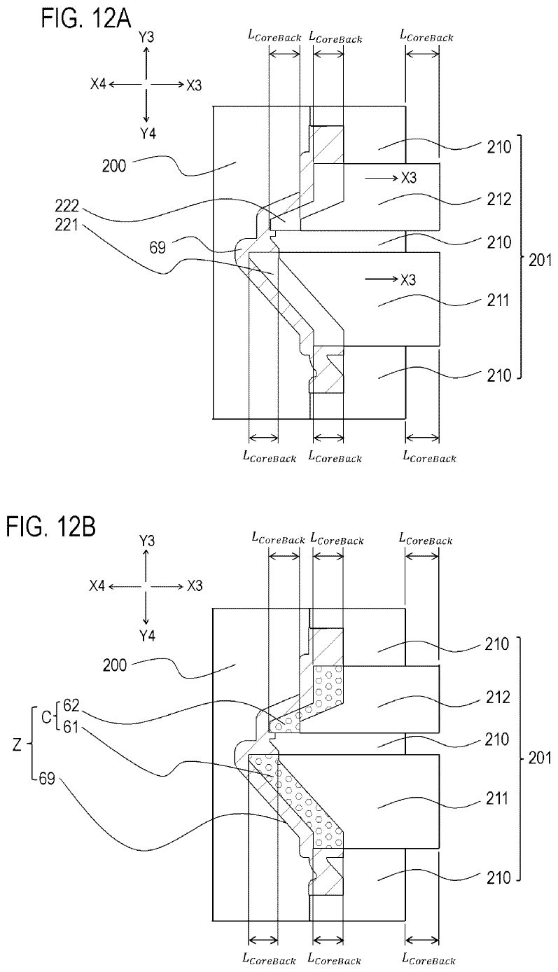

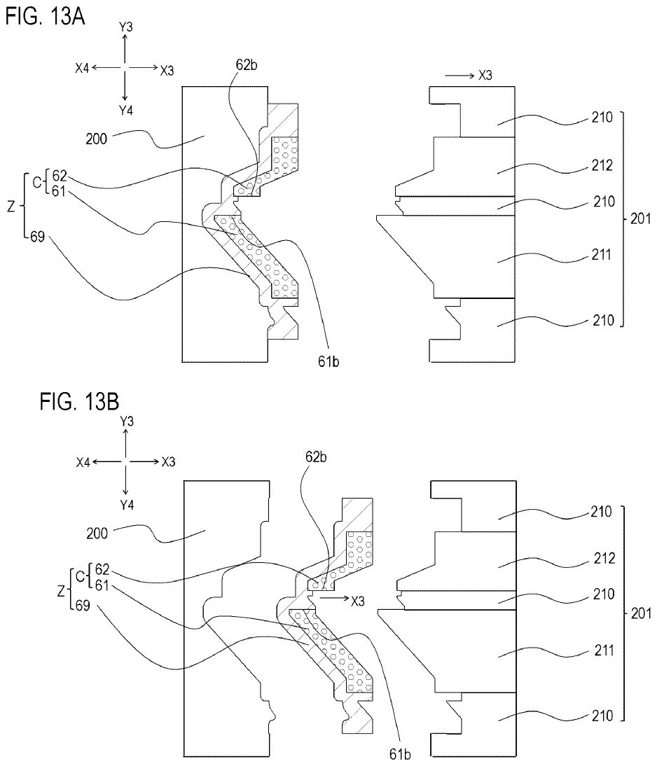

After the electrode holder 69 is formed, as illustrated in FIG. 12A, the detection capacitor mold first core back portion 211 and the detection capacitor mold second core back portion 212 are moved by the core back amount L_{Coreback} toward the detection capacitor nearest vertical direction X3. The detection capacitor mold first core back space 221 is formed in the mold by the core back of the detection capacitor mold first core back portion 211. Similarly, the detection capacitor mold second core back space 222 is formed in the mold by the core back of the detection capacitor mold second core back portion 212. When the conductive resin that is the second material for molding is molded in this state, the detection capacitor C including the first electrode 61 and the second electrode 62 is formed (secondary molding) as illustrated in FIG. 12B. The thickness of the detection capacitor C in the detection capacitor nearest vertical direction X4 is substantially equal to the product of the core back amount L_{Coreback} and the molding shrinkage rate of the conductive resin. That is, the thicknesses of the first electrode 61 and the second electrode 62 in the normal direction of detection capacitor connection wall surfaces 52a and 52b are substantially equal. As illustrated in FIG. 13A, the detection capacitor mold core 201 is moved in the detection capacitor nearest vertical direction X3 after the detection capacitor C is formed. Finally, as illustrated in FIG. 13B, the detection capacitor C moves in the detection capacitor nearest vertical direction X3 with respect to the detection capacitor mold cavity 200. As a result, the remaining amount detection member Z is released from the detection capacitor mold cavity 200 and the detection capacitor mold core 201, and the conductive two-color molding is completed.

As illustrated in FIGS. 11A to 11C to 13A and 13B, the detection capacitor C is formed by the core back of the detection capacitor mold core 201. Therefore, a first electrode tip facing surface 61b (first facing surface) and a second electrode tip facing surface 62b (second facing surface) are formed parallel to each other in the detection capacitor nearest vertical directions X3 and X4 which are the core back directions. By the above procedure, the conductive two-color molding of the remaining amount detection member Z including the detection capacitor C and the electrode holder 69 is completed.

### Configuration of Remaining Amount Detection Member Z

As illustrated in FIGS. 1 and 15, the developing unit 50 is provided with the developing frame 52, the stirring member 63, and the remaining amount detection member Z. The stirring member 63 includes the stirring shaft 63a and a stirring sheet 63b, and is pivotally supported to the developing frame 52 so as to be rotatable in a stirring sheet rotation direction R6 around the rotation shaft center 63c of the stirring member 63 (around the rotation axis of the stirring shaft 63a). One end of the stirring sheet is fixed to the stirring shaft 63a, and the other end side bends along the inner wall of the toner accommodating portion 60 as a free end, and the toner is cyclically stirred at time intervals of the stirring period T_{Age}. That is, the stirring sheet 63b has a fixed end fixed to the stirring shaft 63a and a free end opposite to the fixed end in a direction (first direction) orthogonal to the rotation axis. The length from the fixed end to the free end is a length that can come into contact with the inner wall (at least the first wall surface 57 and the second wall surface 59) of the developing frame 52 forming the toner accommodating portion 60.

The electrode holder 69 forming the remaining amount detection member Z is integrally connected to the two detection capacitor connection wall surfaces 52a and 52b provided in the developing frame 52. Meanwhile, the detection capacitor C illustrated in FIG. 15 is also integrally connected to a detection capacitor connection first side wall 52c and a detection capacitor connection second side wall 52d at both ends in the longitudinal directions Z1 and Z2. That is, the detection capacitor C is integrally connected to the developing frame 52 along a closed curved connection surface including the detection capacitor connection wall surfaces 52a and 52b, the detection capacitor connection first side wall 52c, and the detection capacitor connection second side wall 52d. These connection surfaces (detection capacitor connection wall surfaces 52a and 52b, detection capacitor connection first side wall 52c, detection capacitor connection second side wall 52d) are surfaces connected to the outer wall of the developing frame 52, and are substantially parallel to the rotation axis of the stirring member 63.

In addition, the first electrode 61 forming the detection capacitor C is arranged with an inclination of a first electrode inclination angle θ61 set to be larger than the angle of repose of the toner with respect to the horizontal directions X1 and X2. The nearest direction (hereinafter, referred to as detection capacitor nearest directions Y3 and Y4) of the first electrode 61 and the second electrode 62 is provided substantially parallel to the detection capacitor connection wall surfaces 52a and 52b. In other words, the detection capacitor nearest vertical directions X3 and X4 perpendicular to the detection capacitor nearest directions Y3 and Y4 are provided substantially perpendicular to the detection capacitor connection wall surfaces 52a and 52b. A distance L_{Bond} between the stirring center and the detection capacitor connection inner wall, which is a distance from the rotation shaft center 63c of the stirring member 63 to the inner wall side of the toner accommodating portion 60 of the detection capacitor connection wall surfaces 52a and 52b, is shorter than a distance L_{Cap} between the stirring center and the detection capacitor start end, which is a distance from the rotation shaft center 63c to the detection capacitor connection wall surfaces 52a and 52b. The distance L_{Bond} between the stirring center and the detection capacitor connection inner wall is a distance from the rotation shaft center 63c to a region of the inner wall of the developing frame 52 corresponding to the detection capacitor connection wall surfaces 52a and 52b continuous with the outer wall of the developing frame 52.

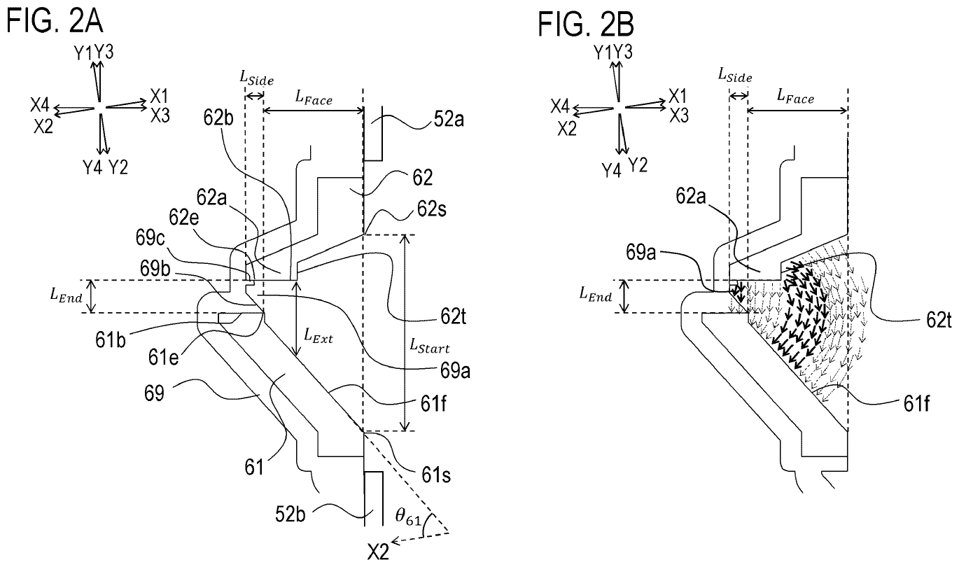

As illustrated in FIG. 2A, the first electrode 61 has a first electrode starting end 61s (first starting end) far from the second electrode 62 and a first electrode terminating end 61e (first terminating end) close to the second electrode 62 around the rotation axis of the stirring member 63. Similarly, the second electrode 62 has a second electrode starting end 62s (second starting end) far from the first electrode 61 and a second electrode terminating end 62e (second terminating end) close to the first electrode 61 around the rotation axis of the stirring member 63. The first electrode starting end 61s, which is one end of the first electrode 61 in the detection capacitor nearest directions Y3 and Y4, is formed on substantially the same plane as the detection capacitor connection wall surfaces 52a and 52b. Similarly, the second electrode starting end 62s, which is one end of the second electrode 62 in the detection capacitor nearest directions Y3 and Y4, is formed on substantially the same plane as the detection capacitor connection wall surfaces 52a and 52b. Therefore, when the free end of the stirring sheet 63b conveys the toner toward the detection capacitor C following the inner wall of the toner accommodating portion 60, the detection capacitor C, that is, the first electrode 61 and the second electrode 62 are provided on the side farther from the free end of the stirring sheet 63b than the detection capacitor connection wall surfaces 52a and 52b in the detection capacitor nearest vertical directions X3 and X4 which are the penetration directions of the stirring sheet 63b with respect to the inner wall of the toner accommodating portion 60. The detection capacitor connection first side wall 52c and the detection capacitor connection second side wall 52d illustrated in FIG. 15 are formed on the same surfaces as the detection capacitor connection wall surfaces 52a and 52b illustrated in FIGS. 1, 2A, and 2B. Therefore, the relationship that the distance L_{Bond} between the stirring center and the detection capacitor connection inner wall is shorter than the distance L_{Cap} between the stirring center and the detection capacitor start end is satisfied.

As illustrated in FIGS. 1 and 2A, the first electrode 61 has the first electrode terminating end 61e which is the other end side in the detection capacitor nearest directions Y3 and Y4. In the first electrode 61, a first electrode exposed portion 61f is formed between the first electrode starting end 61s and the first electrode terminating end 61e. Meanwhile, the second electrode 62 has a second electrode terminating end 62e which is the other end side in the detection capacitor nearest directions Y3 and Y4. In the second electrode 62, an electrode protruding portion 62a which is a protrusion protruding in the detection capacitor nearest direction Y4 toward the first electrode 61 is formed between the second electrode starting end 62s and the second electrode terminating end 62e. The electrode protruding portion 62a is formed of the second electrode tip facing surface 62b having normal lines in the detection capacitor nearest directions Y3 and Y4 and a second electrode shear surface 62t having normal lines in the detection capacitor nearest vertical directions X3 and X4. The second electrode tip facing surface 62b is an end surface of the second electrode terminating end 62e substantially parallel to the rotation axis of the stirring member 63 and extending in the normal direction of the detection capacitor connection wall surfaces 52a and 52b, and is a surface substantially parallel to the first electrode tip facing surface 61b which is an end surface of the first electrode terminating end 61e. The electrode protruding portion 62a is a corner of the second electrode 62 including the second electrode tip facing surface 62b and the second electrode shear surface 62t continuous with the second electrode tip facing surface 62b. In addition, the first electrode tip facing surface 61b and the second electrode tip facing surface 62b have regions that are orthogonal to the rotation axis of the stirring member 63 and overlap each other when viewed in the direction along the detection capacitor connection wall surfaces 52a and 52b. The shortest distance between the first electrode 61 and the second electrode 62 in the same direction is formed between the first electrode tip facing surface 61b and the second electrode tip facing surface 62b. That is, a distance L_{Start} between the electrode starting ends is a distance between the first electrode starting end 61s and the second electrode starting end 62s in the detection capacitor nearest directions (Y3 and Y4) in the direction orthogonal to the rotation axis of the stirring member 63 and along the detection capacitor connection wall surfaces 52a and 52b. A distance L_{End} between the electrode terminating ends is a distance between the first electrode terminating end 61e and the second electrode terminating end 62e in the detection capacitor nearest directions Y3 and Y4 in the same direction. The distance L_{Start} between the electrode starting ends is longer than the distance L_{End} between the electrode terminating ends. The first electrode terminating end 61e and the second electrode terminating end 62e are disposed on the detection capacitor nearest vertical direction X4 side with respect to the first electrode starting end 61s and the second electrode starting end 62s, that is, on the farther side with respect to the rotation shaft center 63c of the stirring member 63. The electrode protruding portion distance L_{Ext}, which is the distance between the electrode protruding portion 62a and the first electrode exposed portion 61f in the detection capacitor nearest directions Y3 and Y4, is provided between the distance L_{End} between the electrode terminating ends and the distance L_{Start} between the electrode starting ends. The distance L_{End} between the electrode terminating ends is provided between 1 mm and 2.5 mm from the viewpoint of stabilization of the remaining amount detection signal V_{(SNS(t))} by securing the capacitance of the detection capacitor C and maintenance of mass productivity by securing the strength of the detection capacitor mold core base portion 210.

The first electrode 61 and the second electrode 62 of the detection capacitor C face each other at the exposed portions of the first electrode and the second electrode in a detection capacitor facing region L_{Face} that are components in the detection capacitor nearest vertical direction X3 or X4 of the first electrode exposed portion 61f. Meanwhile, a first non-facing shielding wall 69b and a second non-facing shielding wall 69c are provided in the detection capacitor non-facing region L_{Side} provided adjacent to the detection capacitor facing region L_{Face} in the detection capacitor nearest vertical direction X4. The first non-facing shielding wall 69b and the second non-facing shielding wall 69c shield a part of the first electrode tip facing surface 61b and a part of the second electrode tip facing surface 62b within the region of the distance L_{End} between the electrode terminating ends in the detection capacitor nearest directions (Y3 and Y4) of the electrode holder 69. Specifically, the first non-facing shielding wall 69b is a wall portion (first wall portion) of the electrode holder 69 that is in contact with the first electrode tip facing surface 61b and protrudes along the first electrode tip facing surface 61b toward the rotation axis of the stirring member 63. Similarly, the second non-facing shielding wall 69c is a wall portion (second wall portion) of the electrode holder 69 that is in contact with the second electrode tip facing surface 62b and protrudes along the second electrode tip facing surface 62b toward the rotation axis of the stirring member 63. The first non-facing shielding wall 69b is arranged at the first electrode inclination angle θ61 similarly to the first electrode exposed portion 61f. In addition, an electrode recessed portion 69a, which includes the detection capacitor non-facing region L_{Side}, the region of the distance L_{End} between the electrode terminating ends, the first non-facing shielding wall 69b, and the second non-facing shielding wall 69c and is a space capable of accommodating the toner, is provided between the first electrode 61 and the second electrode 62. The electrode recessed portion 69a is recessed in a direction away from the rotation axis of the stirring member 63 between the first non-facing shielding wall 69b and the second non-facing shielding wall 69c. The first electrode 61 and the second electrode 62 are electrically arranged in a non-contact manner by the electrode recessed portion 69a having a gap of the distance L_{End} between the electrode terminating ends, thereby forming the detection capacitor C.

The first electrode exposed portion 61f which is an exposed portion in the toner accommodating portion (storage chamber) 60 of the first electrode 61 is arranged at a first electrode inclination angle θ61 set to be larger than the repose angle of the toner. Therefore, after the stirring sheet 63b comes out in the detection capacitor nearest direction Y3 with respect to the detection capacitor C, the toner on the first electrode 61 falls in the vertical direction Y2 under the action of gravity. Therefore, it is possible to prevent the toner entering between the first electrode 61 and the second electrode 62 from staying in the toner moving in and out of the detection capacitor C by the rotation of the stirring member 63 illustrated in FIG. 1. In addition, the electrode protruding portion distance L_{Ext}, the distance L_{End} between the electrode terminating ends, and the distance L_{Start} between the electrode starting ends which are inter-electrode distances of the detection capacitor, are formed by the conductive two-color molding of the remaining amount detection member Z illustrated in FIGS. 11A to 11C to 13A and 13B, respectively. The distance between the electrodes, which is a characteristic factor of the capacitance of the detection capacitor C, is determined by the mold accuracy of two-color molding and the management of molding conditions. Therefore, as compared with a case where the capacitor electrode is provided by assembling, bonding, or the like of a plurality of parts, it is possible to eliminate fitting backlash during assembly and variation due to a bonding position tolerance. Since the amplitude ΔV in the remaining amount detection signal V_{(SNS(t))} is further stabilized by suppressing the tolerance of the inter-electrode distance, it is possible to detect the toner remaining amount with high accuracy.

As illustrated in FIG. 2B, an electric field that forms capacitance is formed between the first electrode 61 and the second electrode 62. Since the second electrode 62 is provided with the electrode protruding portion 62a, the edge effect of the line of electric force generated from the second electrode shear surface 62t of the electrode protruding portion 62a is added. The capacitance of the detection capacitor C increases due to the edge effect as compared with the case where the electrode protruding portion 62a is not provided. As the capacitance increases, the amplitude ΔV of the remaining amount detection signal V_{(SNS(t))} increases, so that it is possible to detect the toner remaining amount with high accuracy.

In addition, the detection capacitor C, that is, the first electrode 61 and the second electrode 62 are arranged on the side far from the free end of the stirring sheet 63b, that is, on the concave side with respect to the same plane including the detection capacitor connection wall surfaces 52a and 52b, the detection capacitor connection first side wall 52c, and the detection capacitor connection second side wall 52d illustrated in FIGS. 1 and 15. Therefore, as compared with the case where the first electrode 61 and the second electrode 62 are disposed on the convex side with respect to the detection capacitor connection wall surfaces 52a and 52b, the toner is prevented from falling over at the time of pumping and conveying the toner to the detection capacitor C by the stirring sheet 63b. Since the pulsating waveform of the remaining amount detection signal V_{(SNS(t))} is further stabilized by suppressing the toner falling off, it is possible to detect the toner remaining amount with high accuracy.

The first non-facing shielding wall 69b and the second non-facing shielding wall 69c are arranged to face each other via the electrode recessed portion 69a in the detection capacitor nearest directions Y3 and Y4. Therefore, at the time of injection of the conductive resin which is the second material of the conductive two-color molding illustrated in FIG. 12B, resin leakage of the conductive resin of the first electrode 61 and the second electrode 62 from the gap between the detection capacitor mold core base portion 210 and the electrode holder 69 is prevented by the labyrinth action. Since electrical insulation between the first electrode 61 and the second electrode 62 can be stably performed by preventing the resin leakage, mass productivity of conductive two-color molding can be secured. In the detection capacitor non-facing region L_{Side}, the first electrode 61 and the second electrode 62 are not disposed to face each other in an exposed state, but lines of electric force are generated by providing the electrode recessed portion 69a. In addition, since the electrode recessed portion 69a can form a minute gap equal to or less than the distance L_{End} between the electrode terminating ends, the strongest electric field can be formed in the detection capacitor C. As a result, since the capacitance of the detection capacitor C increases as compared with the case where the electrode recessed portion 69a is not provided, the amplitude ΔV increases similarly to the electrode protruding portion 62a, so that it is possible to detect the toner remaining amount with high accuracy.

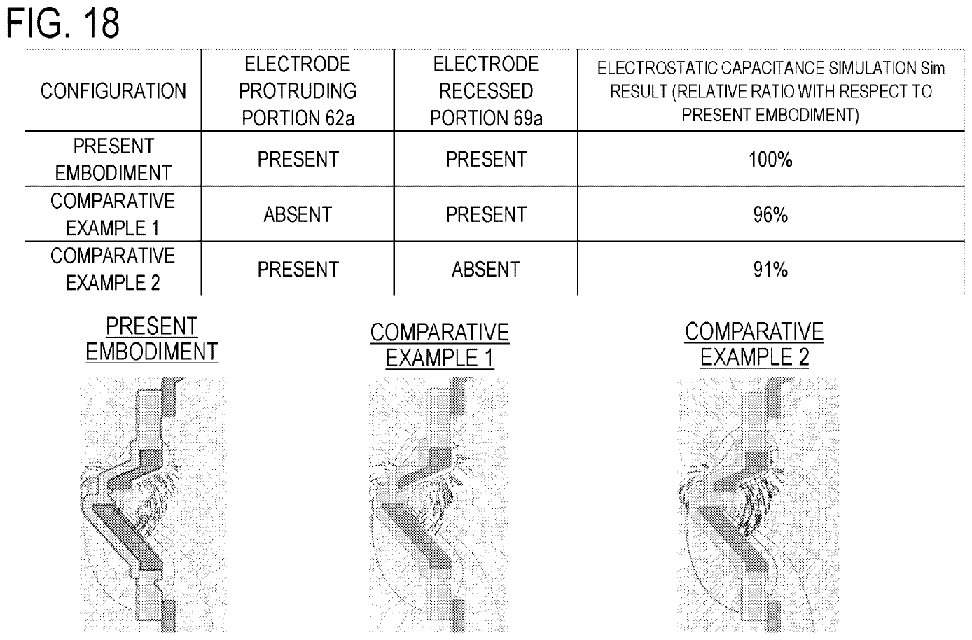

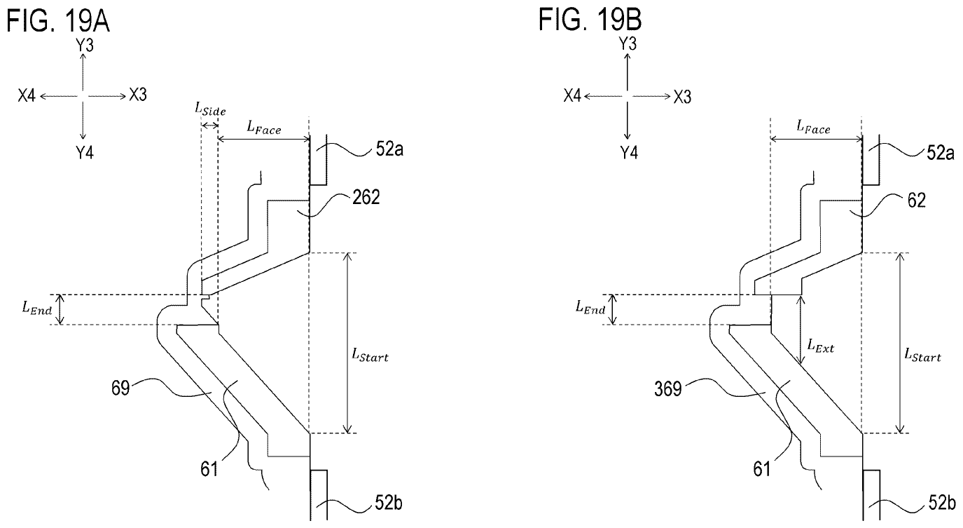

The effect of the present embodiment by the capacitance simulation will be described with reference to FIGS. 18, 19A, and 19B. FIGS. 19A and 19B are Comparative Examples of the detection capacitor C according to the present embodiment. FIG. 18 illustrates results of capacitance simulation of the present embodiment and Comparative Example illustrated in FIGS. 19A and 19B. A second electrode 262 of Comparative Example 1 illustrated in FIG. 19A has a configuration in which the electrode protruding portion 62a is removed from the second electrode 62 of the present embodiment. Meanwhile, an electrode holder 369 of Comparative Example 2 illustrated in FIG. 19B has a configuration in which the electrode recessed portion 69a is removed from the electrode holder 269 of the present embodiment. As illustrated in the capacitance simulation result of FIG. 18, in the present embodiment (with electrode protruding portion 62a), the capacitance improvement effect of about 4% can be obtained with respect to Comparative Example 1 (without electrode protruding portion 62a), and the capacitance improvement effect of about 9% can be obtained with respect to Comparative Example 2 (without electrode recessed portion 69a).

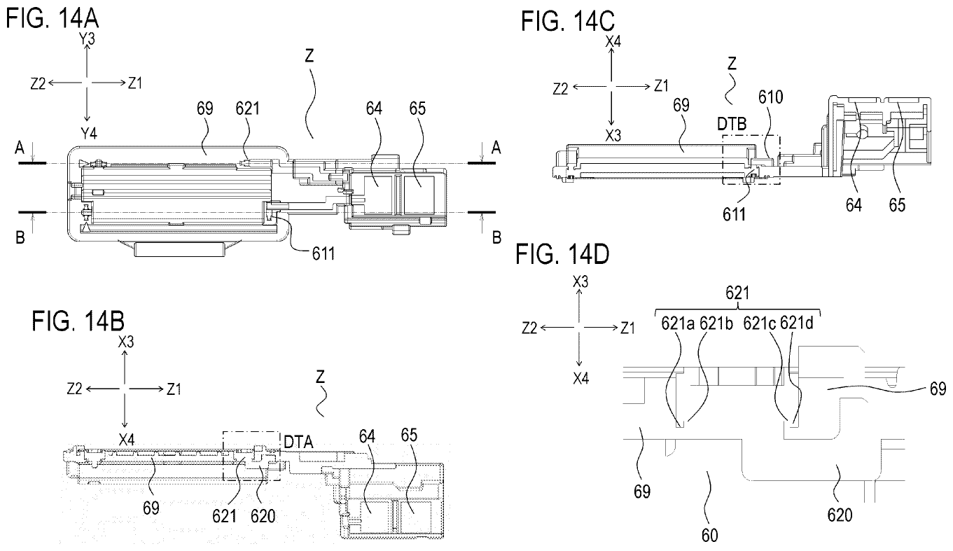

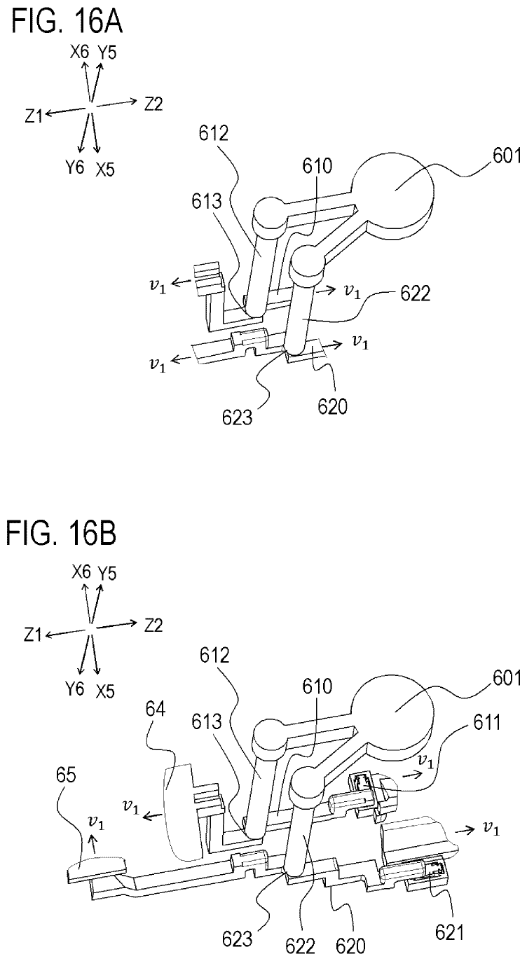

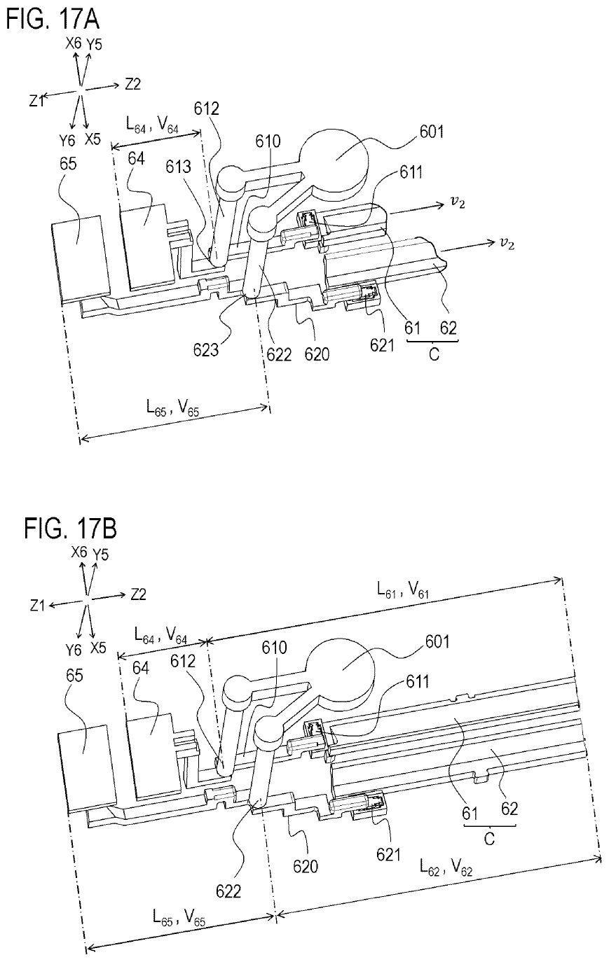

The conductive resin configuration of the remaining amount detection member Z will be described with reference to FIGS. 6A, 6B, 14A to 14D, 16A, 16B, 17A, and 17B. FIG. 14A is a front view illustrating a configuration of the remaining amount detection member Z. FIGS. 14B and 14C are longitudinal cross-sectional views illustrating the toner sealing configuration of FIG. 14A, respectively. FIG. 14D is a detailed view of the toner sealing configuration illustrated in FIGS. 14B and 14C. FIGS. 16A, 16B, 17A, and 17B are explanatory diagrams of a resin flow passage and a gate arrangement configuration in conductive resin molding of the detection capacitor C and the electrical contacts 64 and 65.

As illustrated in FIGS. 14A, 6A, and 6B, the remaining amount detection member Z is the toner remaining amount detection signal detection member of a capacitance type including the electrode holder 69, the detection capacitor C, and the electrical contacts 64 and 65, and is manufactured by the conductive two-color molding illustrated in FIGS. 11A to 11C to 13A and 13B. As illustrated in FIG. 14C, the first electrical contact 64 and the first electrode 61 are integrally molded via the first electrode flow passage 610 and the first electrode toner sealing portion 611 in the conductive resin molding step illustrated in FIG. 12B, and thus, are electrically connected to each other. As illustrated in FIG. 14B, the second electrical contact 65 and the second electrode 62 are also integrally molded via the second electrode flow passage 620 and the second electrode toner sealing portion 621 in the conductive resin molding step illustrated in FIG. 12B, and thus, are electrically connected to each other. In addition, the conductive resin in the present embodiment is formed of conductive POM composed of polyacetal (POM) containing about 10% of carbon black (hereinafter, referred to as CB). The insulating resin of the electrode holder 69 is a PS+PPE resin, but is not limited thereto.

As illustrated in FIG. 14D, the second electrode flow passage 620 and the second electrode toner sealing portion 621 are integrally molded with a conductive resin, and are integrally coupled to the electrode holder 69. Since the first electrode flow passage 610 and the first electrode toner sealing portion 611 have the same configuration, a toner sealing configuration by the second electrode toner sealing portion 621 and the second electrode flow passage 620 will be described here.

The second electrode toner sealing portion 621 includes second electrode toner sealing protruding portions 621a and 621d and second electrode toner sealing recessed portions 621b and 621c. The second electrode toner sealing protruding portions 621a and 621d are disposed outside the second electrode toner sealing recessed portions 621b and 621c in the longitudinal directions Z1 and Z2 and in the detection capacitor nearest vertical direction X4 which is the side toward the toner accommodating portion 60. In other words, the second electrode toner sealing recessed portions 621b and 621c are arranged in the detection capacitor nearest vertical direction X3 which is the inner side in the longitudinal directions Z1 and Z2 and the side away from the toner accommodating portion 60 with respect to the second electrode toner sealing protruding portions 621a and 621d.

The electrical contacts 64 and 65 and the detection capacitor C are molded in the sequence of FIGS. 16A, 16B, 17A, and 17B. First, as illustrated in FIG. 16A, the conductive resin injected from an injection molding machine (not illustrated) into the runner 601 at a predetermined injection speed is branched into the first electrode gate portion 612 and the second electrode gate portion 622. The conductive resin flowing through the first electrode gate portion 612 starts to flow to the first electrode flow passage 610 via a first gate connection portion 613. Similarly, the conductive resin flowing through the second electrode gate portion 622 starts to flow to the second electrode flow passage 620 via a second gate connection portion 623. The first gate connection portion 613 is an introduction port of a conductive resin provided in the middle of the first electrode flow passage 610 as a conductive path connecting the first electrode 61 and the first electrical contact 64. The second gate connection portion 623 is an introduction port of a conductive resin provided in the middle of the second electrode flow passage 620 as a conductive path connecting the second electrode 62 and the second electrical contact 65. Next, as illustrated in FIG. 16B, the first electrode flow passage 610 and the second electrode flow passage 620 branch off toward the longitudinal direction Z1, which is a side toward the electrical contacts 64 and 65, and the longitudinal direction Z2, which is a side toward the detection capacitor C. Further, as illustrated in FIG. 17A, the conductive resin on the longitudinal direction Z2 side flows to a part of the detection capacitor C beyond the first electrode toner sealing portion 611 and the second electrode toner sealing portion 621. At this stage, filling of the conductive resin on the longitudinal direction Z1 side is performed by a first electrical contact molding distance L₆₄ and a second electrical contact molding distance L₆₅, respectively, and the filling of the electrical contacts 64 and 65 is completed. The resin filling volumes from the gates (gate connection portions 613 and 623) to the electrical contacts 64 and 65 at this time are defined as a first electrical contact molding volume V₆₄ and a second electrical contact molding volume V₆₅, respectively. As illustrated in FIG. 17A, the conductive resin injected from the injection molding machine (not illustrated) to the runner 601 at a predetermined injection speed does not branch in the longitudinal direction Z1 which is the side toward the electrical contacts 64 and 65 in the first electrode flow passage 610 and the second electrode flow passage 620, but the filling of the conductive resin is performed only in the longitudinal direction Z2 which is the side toward the detection capacitor C. Therefore, according to the flow rate law, with respect to a flow rate v₁ before electrical contact formation which is a flow rate until the electrical contacts 64 and 65 are formed illustrated in FIGS. 16A and 16B, as illustrated in FIG. 17A, a flow rate v₂ after electrical contact formation, which is the flow rate until the molding of the detection capacitor C is completed after the electrical contacts 64 and 65 are molded, is higher than the flow rate v₁ before electrical contact formation. Finally, as illustrated in FIG. 17B, when the molding of the detection capacitor C is completed, filling of the conductive resin on the longitudinal direction Z2 side is performed by a first electrode molding distance L₆₁ and a second electrode molding distance L₆₂, respectively. The resin filling volume from each gate to the detection capacitor C at this time is defined as a first electrode molding volume V₆₁ and a second electrode molding volume V₆₂, respectively. In order to satisfy the relationship of the flow rate v₁ before electrical contact formation<the flow rate v₂ after electrical contact formation, each of the first electrode gate portion 612 and the second electrode gate portion 622 is disposed so as to satisfy the relationship of the following equation.

First electrical contact molding volume V₆₄<first electrode molding volume V₆₁

Second electrical contact molding volume V₆₅<second electrode molding volume V₆₂

In the remaining amount detection member Z of the present embodiment, in the conductive two-color molding, the second electrode toner sealing protruding portions 621a and 621d are tightened to the inside of the second electrode toner sealing recessed portions 621b and 621c in the longitudinal directions Z1 and Z2 by molding shrinkage, thereby sealing the toner in the toner accommodating portion 60. Here, when the material of the developing frame 52 illustrated in FIG. 1 is a PS resin, compatibility with the electrode holder 69 is obtained. Therefore, it is possible to perform bonding by a method such as ultrasonic welding or thermal caulking without using another material such as an adhesive or a tape from the viewpoint of securing strength, cost reduction, and environmental load reduction. In addition, since the first electrical contact 64, the first electrode 61, the first electrode flow passage 610, and the first electrode toner sealing portion 611 are all integrated by conductive two-color molding, there is no contact resistance between these elements, and only an internal resistance exists. Similarly, there is no contact resistance between the respective elements of the second electrical contact 65, the second electrode 62, the second electrode flow passage 620, and the second electrode toner sealing portion 621, and only internal resistance exists. Therefore, with respect to the configuration in which the electrical contacts 64 and 65 and the detection capacitor C are provided as separate components and are electrically connected to each other, the contact resistance between the components is eliminated, so that it is possible to suppress the parasitic resistance R that is the factor of attenuation of the remaining amount detection signal V_{(SNS(t))}.

In addition, in the remaining amount detection member Z of the present embodiment, since the relationship of the flow rate v₁ before electrical contact formation<the flow rate v₂ after electrical contact formation is satisfied, the injection speed of the conductive resin at the electrical contacts 64 and 65 can be kept low. By suppressing the injection speed of the conductive resin to be low, shear fracture of the CB contained in the conductive resin is suppressed on the surfaces of the electrical contacts 64 and 65 formed by the skin layer with the mold, so that the conductive action by the CB is maintained even after molding. As a result, the increase in the surface resistance of the electrical contacts 64 and 65 is prevented, so that the contact resistance with the electrical contact springs 90 and 91 illustrated in FIGS. 8A, 8B, and 9A to 9C is suppressed. Therefore, it is possible to suppress the parasitic resistance R that is the factor of attenuation of the remaining amount detection signal V_{(SNS(t))}. Meanwhile, the surface resistance of the detection capacitor C charged at the flow rate v₂ after electrical contact formation is higher than the surface resistance of the electrical contacts 64 and 65 due to shear fracture of the CB from the relationship of the flow rate v₁ before electrical contact formation<the flow rate v₂ after electrical contact formation. However, since the detection capacitor C is only configured to detect a change in capacitance due to entrance and exit of toner in the toner accommodating portion 60 as capacitive reactance, an increase in surface resistance in the detection capacitor C does not cause the factor of attenuation of the remaining amount detection signal V_{(SNS(t))}. For this reason, in the integrated configuration of the electrical contacts 64 and 65 and the detection capacitor C made of the conductive resin, in order to reduce the surface contact resistance as a member of the parasitic resistance R as much as possible, the injection speed of the conductive resin at the electrical contacts 64 and 65 is configured such that is suppressed to be lower than that at other filling portions.

According to the present disclosure, a cartridge or an electrophotographic image forming apparatus can be developed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-035942, filed on Mar. 6, 2025, which is hereby incorporated by reference herein in its entirety.

What is claimed is:

1. An image forming apparatus comprising:
an apparatus body having a body contact; and
a cartridge detachably mountable to the apparatus body, the cartridge including a first unit having a photosensitive drum and a second unit having a developing roller for supplying toner to the photosensitive drum, and an electrical contact brought into contact with the body contact, the first unit and the second unit moving about a pivot axis between a contact position at which the photosensitive drum and the developing roller come into contact with each other and a spaced-apart position where the photosensitive drum and the developing roller are spaced apart from each other;
wherein, when viewed in a direction of the pivot axis,
in a case where a downstream-side end of the electrical contact is a first end and an upstream-side end of the electrical contact is a second end in a rotation direction about the pivot axis in a case where the second unit moves from the spaced-apart position to the contact position,
the body contact comes into contact with a region of the electrical contact between the first end and a midpoint of the first end and the second end in a case where the second unit is at the contact position, and
the body contact maintains contact with the electrical contact while the second unit moves between the spaced-apart position and the contact position, and
wherein in a case where a distance between the first end and the pivot axis is D1, a distance between the second end and the pivot axis is D2, and a distance between the midpoint and the pivot axis is Dc,
Dc≤D1 and Dc≤D2 are satisfied.

2. The image forming apparatus according to claim 1,
wherein the body contact comes into contact with the electrical contact at a position between the midpoint and the second end in a case where the second unit is in the spaced-apart position.

3. The image forming apparatus according to claim 1,
wherein the electrical contact is provided parallel to the pivot axis.

4. The image forming apparatus according to claim 1,
wherein an attachment/detachment direction of the cartridge with respect to the apparatus body is orthogonal to the pivot axis.

5. The image forming apparatus according to claim 4,
wherein, when viewed in the direction of the pivot axis, the attachment/detachment direction is orthogonal to a line segment connecting the pivot axis and the midpoint.

6. The image forming apparatus according to claim 1,
wherein the electrical contact includes a contact surface including a line connecting the first end and the second end, and
wherein the contact surface faces upward in a vertical direction.

7. The image forming apparatus according to claim 1,
wherein the apparatus body has a pressing portion, and
wherein the second unit has a pressed portion and moves from the contact position to the spaced-apart position by pressing the pressed portion by the pressing portion.

8. The image forming apparatus according to claim 1,
wherein the body contact includes a first body contact and a second body contact,
wherein the electrical contact includes a first electrical contact and a second electrical contact, and
wherein the first body contact and the second body contact, and the first electrical contact and the second electrical contact are arranged in the direction of the pivot axis.

9. The image forming apparatus according to claim 8,
wherein the second unit includes:
a frame having an accommodating portion for accommodating developer; and
a first electrode and a second electrode used for detecting capacitance inside the accommodating portion,
wherein the first electrical contact is provided outside the frame and is electrically connected to the first electrode, and
wherein the second electrical contact is provided outside the frame and is electrically connected to the second electrode.
